(19) United States
(12) Patent Application Publication
(10) Pub. No.: US 2005/0043174 A1
(43) Pub. Date: Feb. 24, 2005

(54) Thermosensitive-recording process and thermosensitive-recording apparatus

(75) Inventors: Shinichiro Serizawa, Shizuoka (JP); Yoshisada Nakamura, Shizuoka (JP); Yasuhiro Ogata, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/921,964

(22) Filed: Aug. 20, 2004

(30) Foreign Application Priority Data
Aug. 22, 2003 (JP) 2003-208488
Aug. 22, 2003 (JP) 2003-208489
Aug. 22, 2003 (JP) 2003-208490

(51) Int. Cl. B41M 5/20

(52) U.S. Cl. 503/201

(57) ABSTRACT

The thermosensitive-recording process according to the present invention comprises recording an image on a thermosensitive-recording material through heating the thermosensitive-recording material that comprises a thermosensitive-recording layer on a support, and smoothening the thermosensitive-recording material, wherein said smoothening the thermosensitive-recording material is carried out during at least a period selected from (i) before recording the image, (ii) while recording the image, and (iii) after recording the image, and the heating temperature at smoothening the thermosensitive-recording material is above 70° C. and below 170° C.

### BACKGROUND OF THE INVENTION

1. Field of the Invention

The present invention relates to a thermosensitive-recording process and a thermosensitive-recording apparatus capable of recording images on thermosensitive-recording materials with high surface smoothness and superior gloss in particular.

2. Description of the Related Art

Thermosensitive-recording processes combined with thermosensitive-recording materials provide generally the following various benefits: (i) development of images is unnecessary, (ii) properties of the thermosensitive-recording materials are similar to those of conventional paper when the support is of paper, (iii) handling is simple, (iv) coloring density is high, (v) recording apparatus is simple, reliable and inexpensive, (vi) noise level is low at recording, and (vii) maintenance is substantially free. Accordingly, thermosensitive-recording processes are growing recently in various technical fields; for example the applications are enlarging in recording devices of facsimile and printer, and label-forming devices of POS and the like.

As for such thermosensitive recording material in the prior art, a thermosensitive-recording material comprising a support, and a cyan thermosensitive-recording layer, magenta thermosensitive-recording layer, and yellow thermosensitive-recording layer on the support in order is proposed (see Japanese Patent Application Laid-Open (JP-A) No. 2002-187361). In the thermosensitive-recording material, image forming is carried out through applying different levels of thermal energy on the respective thermosensitive-recording layers.

The thermal energy is typically applied by means of a thermal head. However, the recording is carried out through applying a large amount of thermal energy into the thermosensitive layer, in the image recording process that employs the thermal head. Consequently, the surface temperature of the thermosensitive material remarkably rises thereby to expand the moisture or water vapor in the thermosensitive-recording layer, and the expanded moisture or water vapor migrates to the outer coated layer of the thermosensitive-recording material, resulting in the occurrence of pores, so-called blistering.

In order to cause the color developing of the innermost cyan layer of the thermosensitive-recording layer, the temperature of the thermosensitive-recording layer comes to considerably high, the blistering occurrence also comes to considerable. Further, since the thermal head contacts with the thermosensitive-recording material so as to record the images, the surface flatness or smoothness of the thermosensitive-recording material tends to be deteriorated. The occurrence of blistering and the deterioration of flatness cause the decrease of the recorded image quality such as gloss.

Therefore, a variety of thermosensitive-recording materials have been proposed heretofore (e.g. JP-A No. 2003-118230). However, it is still difficult to reduce the occurrence of blistering and to enhance the flatness at the recording surface to improve consequently the recorded image quality such as gloss.

Moreover, in the case that the surface of the thermosensitive-recording material is not sufficiently flat, when images are recorded on the cyan thermosensitive-recording layer adjacent to the support, the concentration may not be uniform due to the surface configuration of the support. In addition, the nonuniform concentration results in lower gloss of the recorded image surface, thus full-color images with high quality are more difficult to be achieved.

As above explained, a thermosensitive-recording process capable of printing full-color images with reduced concentration nonuniformity and with high gloss of the recorded image surface has not been provided yet, and the development is demanded presently.

### SUMMARY OF THE INVENTION

An object of the invention is to provide a thermosensitive-recording process and a thermosensitive-recording apparatus capable of improving image quality such as gloss of recorded images through controlling the occurrence of blistering and enhancing the flatness.

Another object of the invention is to provide a thermosensitive-recording process and a thermosensitive-recording apparatus capable of printing high quality full-color images with reduced concentration nonuniformity and with high gloss of the recorded image surface.

The thermosensitive-recording process according to the present invention comprises recording an image on a thermosensitive-recording material through heating the thermosensitive-recording material which comprises a thermosensitive-recording layer on a support, and smoothening the thermosensitive-recording material, wherein said smoothening the thermosensitive-recording material is carried out during at least a period selected from (i) before recording the image, (ii) while recording the image, and (iii) after recording the image, and the heating temperature at smoothening the thermosensitive-recording material is above 70° C. and below 170° C.

According to the inventive thermosensitive-recording process, the occurrence of blistering may be controlled, the flatness or smoothness may be enhanced, and the image quality such as gloss may be improved. In addition, high quality full-color images may be printed with reduced concentration nonuniformity and with high gloss of the recorded image surface.

The thermosensitive-recording apparatus according to the present invention comprises an image recording unit, and a smoothening unit,
wherein the image recording unit serves to record an image on a thermosensitive-recording material through heating the thermosensitive-recording material which comprises a thermosensitive-recording layer on a support, and the smoothening unit serves to smoothen the thermosensitive-recording material,
wherein the smoothening unit operates during at least a period selected from (i) before recording the image, (ii) while recording the image, and (iii) after recording-the image, and the heating temperature at smoothening the thermosensitive-recording material is above 70° C. and below 170° C.

According to the inventive thermosensitive-recording apparatus, the occurrence of blistering may be controlled, the flatness or smoothness may be enhanced, and the image quality such as gloss may be improved. In addition, high quality full-color images may be printed with reduced concentration nonuniformity and with high gloss of the recorded image surface.

### BRIEF DESCRIPTION OF THE DRAWINGS

FIG. 1 schematically shows a exemplary color thermosensitive-recording paper.

FIG. 2 schematically shows an exemplary image recording apparatus according to the present invention.

FIG. 3 schematically and exemplarily shows a belt-type smoothening device to conduct the smoothening treatment.

### DESCRIPTION OF THE PREFERRED EMBODIMENTS

(Thermosensitive-Recording Process)

The thermosensitive-recording process according to the present invention comprises recording images, smoothening treatment, and the others depending on necessities.

In accordance with the inventive process, the smoothening treatment is carried out at least prior to recording an image in the first aspect, at least along with recording an image in the second aspect, and at least following recording an image in the third aspect. The heating temperature at the smoothening treatment is above 70° C. and below 170° C.

In the first aspect of the smoothening treatment, the thermosensitive-recording layer is subjected to the smoothening treatment before image recording.

In the second aspect of the smoothening treatment, the thermosensitive-recording layer is subjected to the smoothening treatment during image recording, and prior to image recording on the thermosensitive-recording layer adjacent to the support.

In the third aspect of the smoothening treatment, the thermosensitive-recording layer is subjected to the smoothening treatment after image recording.

<Image Recording>

In the image recording, an image is recorded on the thermosensitive-recording layer of the thermosensitive-recording material through heating the thermosensitive-recording material.

The thermosensitive-recording material is comprised of a support, at least one thermosensitive-recording layer, and other layers depending on the requirements.

Support

The support may be properly selected without particular limitations; examples of the support include raw paper, synthetic paper, synthetic resin sheet, coated paper, laminated paper, and the like. The support may be of single layer or laminated layers. Among these, the laminated paper coated with polyolefin resin layers on both sides of the raw paper is particularly preferable.

Raw Paper

The raw paper may be a high quality paper, for example, the paper described in Shashin kogaku no kiso—ginen shashin hen Basic Photography Engineering—Silver Halide Photography, CORONA PUBLISHING CO., LTD. (1979) pp. 223-224, edited by the Institute of Photography of Japan.

The raw paper may be properly selected without particular limitations, provided that it is common or conventional material for support. Examples of the raw paper material include natural pulp of needle-leaf tree or broad-leaf tree, mixture of natural pulp and synthetic pulp and the like.

As for the pulp available for the raw paper, broadleaf tree bleached kraft pulp (LBKP) is preferred from the viewpoint of good balance between surface flatness and smoothness of the raw paper, rigidity and dimensional stability or curling resistance. Needle-leaf bleached kraft pulp (NBKP), broadleaf tree sulfite pulp (LBSP) and the like may also be available.

A beater or refiner and the like may be employed for beating the pulp.

The Canadian Standard Freeness of the pulp is preferably 200 to 440 ml CSF, and more preferably 250 to 380 ml CSF, to control contraction of paper during the treatment.

Various additives, for example, filler, dry paper reinforcer, sizing agent, wet paper reinforcer, fixing agent, pH regulator or other agents and the like may be added, if necessary, to the pulp slurry (hereinafter, referring to “pulp paper material”) which is obtained after beating the pulp.

Examples of the filler include calcium carbonate, clay, kaolin, white clay, talc, titanium oxide, diatomaceous earth, barium sulfate, aluminum hydroxide, magnesium hydroxide and the like.

Examples of the dry paper reinforcer include cationic starch, cationic polyacrylamide, anionic polyacrylamide, amphoteric polyacrylamide, carboxy-modified polyvinyl alcohol and the like.

Examples of the sizing agent include aliphatic salts, rosin, derivatives of rosin such as maleic rosin and the like, paraffin wax, alkyl ketene dimer, alkenyl succinic anhydride (ASA), epoxy aliphatic amide, and the like.

Examples of the wet paper reinforcer include polyamine polyamide epichlorohydrin, melamine resins, urea resins, epoxy polyamide resins, and the like.

Examples of the fixing agent include polyfunctional metal salts such as aluminum sulfate, aluminum chloride, and the like; cationic polymers such as cationic starch, and the like.

Examples of the pH regulator include caustic soda, sodium carbonate, and the like.

Examples of other agents include defoaming agents, dyes, slime control agents, fluorescent whitening agents, and the like.

In addition, softeners may also be added if necessary. For the softeners, ones which are disclosed on pp. 554-555 of Paper and Paper Treatment Manual (Shiyaku Time Co., Ltd.) (1980) and the like may be employed, for example.

These various additives may be used alone or in combination. The loadings of these additives to the pulp paper material may be properly selected; usually the loadings are preferably 0.1 to 1.0% by mass.

The pulp slurry or pulp paper material, to which these various additives are compounded depending on the requirements, was formed into paper by means of paper machine such as hand paper machine, Fortlinear paper machine, round mesh paper machine, twin wire machine, combination machine, and the like, followed by drying to prepare raw paper. In addition, sizing treatment on the surface may be provided at prior to or following the drying if necessary.

The treatment liquid used for sizing the surface may be properly selected without particular limitations. The treatment liquid may be compounded with such material as water-soluble polymers, waterproof materials, pigments, dyes, fluorescent whitening agents, and the like.

Examples of the water-soluble polymer include cationic starch, polyvinyl alcohol, carboxy-modified polyvinyl alcohol, carboxymethyl cellulose, hydroxyethyl cellulose, cellulose sulfate, gelatin, casein, sodium polyacrylate, styrene-maleic anhydride copolymer sodium salt, sodium polystyrene sulfonate, and the like.

Examples of the waterproof material include latex emulsions such as styrene-butadiene copolymer, ethylene-vinyl acetate copolymer, polyethylene, vinylidene chloride copolymer and the like; polyamide polyamine epichlorohydrin and the like.

Examples of the pigment include calcium carbonate, clay, kaolin, talc, barium sulfate, titanium oxide, and the like.

As for the raw paper, in order to improve the rigidity and dimensional stability or curling resistance, it is preferred that the ratio (Ea/Eb) of the longitudinal Young's modulus (Ea) and the lateral Young's modulus (Eb) is within the range of 1.5 to 2.0. When the ratio (Ea/Eb) is less than 1.5 or more than 2.0, the rigidity and curling properties of the thermosensitive-recording material is likely to be inferior, and may cause some problem on the conveying operation.

It has been found that, in general, the “stiffness” of the paper differs depending on the various manners in which the paper is beaten, and the elasticity or modulus of paper produced by paper making process through beating operation may employ “stiffness” of the paper as an important indication. The elastic modulus of the paper may be calculated from the following equation by using the relation of the density and the dynamic modulus that shows the physical properties of a viscoelastic object, and by measuring the velocity of sound propagation in the paper using an ultrasonic oscillator.
E=ρc²(1-n²)
wherein “E” represents dynamic modulus; “ρ” represents density; “c” represents the velocity of sound in paper; and “n” represents Poisson's ratio.

Since n=0.2 or so in a case of ordinary paper, there is not much difference in the calculation, even if the calculation is performed by the following equation:
E=ρc²

Accordingly, if the density of the paper and acoustic velocity are measured, the elastic modulus may be easily calculated. In the above equation, when measuring acoustic velocity, various instruments known in the art may be available, such as Sonic Tester SST-110 (Nomura Shoji Co., Ltd.) and the like.

In the raw paper, it is preferred to employ pulp fibers having a fiber length distribution as disclosed, for example, in JP-A No. 58-68037 (e.g., the sum of 24 mesh on and 42 mesh on is 20 to 45% by mass, and 24 mesh on is 5% or less by mass) in order to give the desired center line average roughness to the surface. Moreover, the center line average roughness may be adjusted by heating and giving a pressure to a surface of the raw paper, with a machine calender, super calender and the like.

The thickness of the raw paper may be properly selected depending on the application, usually 30 to 500 μm is preferred, 50 to 300 μm is more preferred, and 100 to 250 μm is still more preferred. The basis weight of the raw paper may be properly selected depending on the application, for example, 50 to 250 g/m² is preferred, and 100 to 200 g/m² is more preferred.

Synthetic Paper

Synthetic paper is a kind of paper of which the main component is polymer fibers other than cellulose. Examples of the polymer fibers include polyolefin fibers such as polyethylene, polypropylene, and the like.

Synthetic Resin Sheet (Film)

The synthetic resin sheet may be synthetic resin formed in the shape of sheet or film. Examples thereof include polypropylene film, stretched polyethylene film, stretched polypropylene, polyester film, stretched polyester film, nylon film, and the like. Further, films made white by stretching, white films containing white pigment, and the like may be available.

Coated Paper

The coated paper is one produced by coating various resins on at least one surface of substrate such as raw paper, and the coated amount differs depending on the application. Examples of the coated paper include art paper, cast coated paper, Yankee paper, and the like.

The resin coated on the surface of the raw paper may be properly selected without particular limitations, preferably is thermoplastic resin. Examples of the thermoplastic resin include (1) polyolefin resins, (2) polystyrene resins, (3) acryl resins, (4) polyvinyl acetate and derivatives thereof, (5) polyamide resins, (6) polyester resins, (7) polycarbonate resins, (8) polyether(polyacetal) resins, and (9) the other resins. These thermoplastic resins may be used alone or in combination.

The aforesaid (1) polyolefin resins include, for example, olefin resins such as polyethylene and polypropylene, and copolymers of olefin monomers such as ethylene or propylene and the other vinyl monomers. Examples of the copolymer resin of olefin monomer and the other vinyl monomer include ethylene-vinylacetate copolymer, ionomer resin which is copolymer of olefin monomer and acryl acid or methacrylic acid and the like. Further, the derivatives of polyolefin resin include chlorinated polyethylene, chlorosulfonated polyethylene and the like.

The aforesaid (2) polystyrene resins include, for example, polystyrene resin, styrene-isobutylene copolymer, acrylonitrile-styrene copolymer (AS resin), acrylonitrile-butadiene-styrene copolymer (ABS resin), polystyrene-maleicanhydride resin, and the like.

The aforesaid (3) acryl resins include, for example, polyacrylic acid, polyacrylate, polymethacrylic acid, polymethacrylate, polyacrylonitrile, polyacrylamide, and the like.

The esters of polyacrylic acid or polymethacrylic acid exhibit significantly various properties depending on the ester groups. Further, the (3) acryl resins include the copolymers with other monomers (e.g., acrylic acid, methacrylic acid, styrene, vinyl acetate etc.). The polyacrylonitrile is often utilized in copolymers as AS resin or ABS resin rather than a sole polymer.

The aforesaid (4) polyvinyl acetate and derivatives thereof include, for example, polyvinyl acetate, polyvinyl alcohol formed by partially saponify polyvinyl acetate, polyvinyl acetal resins formed by reacting polyvinyl alcohol with aldehyde (e.g., formaldehyde, acetaldehyde, butylaldehyde etc.).

The aforesaid (5) polyamide resins include polycondensation products of diamine and dibasic acid, for example, 6-nylon and 6,6-nylon.

The aforesaid (6) polyester resins include polycondensation products of alcohol and acid, and exhibits a wide variety of properties depending on the combination of the alcohol and acid. Conventional polyethylene terephthalate and polybutylene terephthalate formed from aromatic dibasic acid and divalent alcohol may be exemplified.

The aforesaid (7) polycarbonate resins typically include polycarbonate obtained from bisphenol A and phosgene.

The aforesaid (8) polyether(polyacetal) resins include, for example, polyether resins such as polyethylene oxide and polypropyleneoxide, and polyacetal resins such as polyoxymethylene obtained through ring-opening-polymerization.

The aforesaid (9) the other resins include polyurethane resins obtained through additional-polymerization and the like.

In addition, the thermoplastic resins may be incorporated with pigments or dyes such as brightener, conductive agent, filler, titanium oxide, ultramarine, carbon black, and the like depending on the application.

Laminated Paper

The laminated paper is one which is formed by laminating materials selected from various resins, rubbers, polymer sheets or films on substrate such as raw paper. Examples of the laminating material include polyolefin resins, polyvinyl chloride resins, polyester resins, polystyrene resins, polymethacrylate resins, polycarbonate resins, polyimide resins, triacetyl cellulose, and the like. These resins may be used alone or in combination.

The aforesaid polyolefin is often low-density polyethylene (LDPE); when the heat resistance should be enhanced, preferably, polypropylene, blend of polypropylene and polyethylene, high-density polyethylene (HDPE), blend of high-density polyethylene and low-density polyethylene and the like is utilized. From the viewpoint of cost and laminate applicability in particular, the blend of high-density polyethylene and low-density polyethylene is most preferable.

The blending ratio by mass of the high-density polyethylene and low-density polyethylene is preferably from 1:9 to 9:1, more preferably 2:8 to 8:2, and most preferably from 3:7 to 7:3. When thermoplastic resin layers are formed on both sides of the raw paper, preferably, the back side of the raw paper is formed of high-density polyethylene or a blend of high-density polyethylene and low-density polyethylene. The molecular weight of the polyethylene is not particularly limited, but it is preferable that melt indices of both high-density polyethylene and low-density polyethylene are 1.0 to 40 g/10-minute and that the polyethylene exhibits a suitable extrusion property.

Further, these sheets or films may be applied a treatment so as to take a reflectivity against white color. Examples of such treatment include compounding a pigment such as titanium oxide or the like into the sheets or films.

The thickness of the support is preferably 25 to 300 μm, more preferably 50 to 260 μm, and still more preferably 75 to 220 μm.

[Thermosensitive-Recording Layer]

The thermosensitive-recording layer may be of any constitution provided that at least one layer is formed on the support. The constitution may be for example the first thermosensitive-recording layer, the second thermosensitive-recording layer, the third thermosensitive-recording layer, and the n-th thermosensitive-recording layer in order, starting from the first thermosensitive-recording layer adjacent to the support. The “n” of ‘n-th’ is preferably three.

When “n” is three, the thermosensitive-recording layer comprises the first thermosensitive-recording layer, the second thermosensitive-recording layer, and the third thermosensitive-recording layer in order on the support.

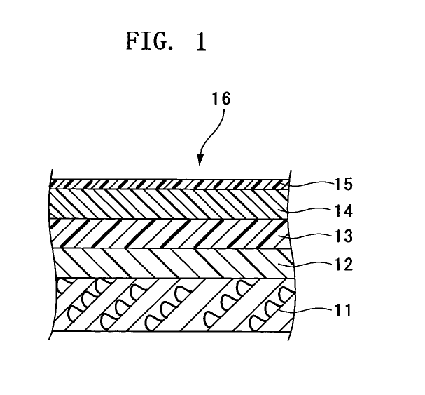

As shown in FIG. 1, color thermosensitive-recording layer 16 comprises cyan thermosensitive-recording layer 12, magenta thermosensitive-recording layer 13, and yellow thermosensitive-recording layer 14 on the support 11. By the way, the order of cyan thermosensitive-recording layer 12, magenta thermosensitive-recording layer 13, and yellow thermosensitive-recording layer 14 may be optionally rearranged.

In the image recording, such embodiments may be possible as recording an image on magenta thermosensitive-recording layer 13 and yellow thermosensitive-recording layer 14, without recording an image on cyan thermosensitive-recording layer 12 adjacent to the support 11, alternatively, as recording an image solely on yellow thermosensitive-recording layer 14, without recording an image on cyan thermosensitive-recording layer 12 and magenta thermosensitive-recording layer 13.

In the first aspect of the thermosensitive-recording process according to the present invention, image recording is carried out on the thermosensitive-recording material smoothened through the smoothening treatment, and the surface of the support may also be smoothened. When the thermosensitive-recording material, comprising the support without the smoothening treatment, is subjected to image recording, the concentration nonuniformity is likely to be induced, resulting in low gloss and inferior image quality. In the first aspect of the present invention, the concentration nonuniformity is controlled at the image recording surface, and images may be produced with high gloss and high quality, since the smoothening treatment is carried out prior to image recording.

In the second aspect of the thermosensitive-recording process according to the present invention, the image recording comprises the primary image recording in which at least one of the second thermosensitive-recording layer and the third thermosensitive-recording layer is subjected to image recording, and the secondary image recording in which the remaining first thermosensitive-recording layer is subjected to image recording; preferably smoothening the thermosensitive-recording material i.e. the smoothening treatment is carried out between the primary image recording and the secondary image recording.

Specifically, color thermosensitive-recording paper 16 may be constituted by providing cyan thermosensitive-recording layer 12, magenta thermosensitive-recording layer 13, and yellow thermosensitive-recording layer 14 on support 11, as shown in FIG. 1. By the way, the order of cyan thermosensitive-recording layer 12, magenta thermosensitive-recording layer 13, and yellow thermosensitive-recording layer 14 may be disposed in an optional order.

In the primary image recording, any one or more thermosensitive-recording layer selected from the thermosensitive-recording layers may be subjected to image recording; preferably, magenta thermosensitive-recording layer 13 and yellow thermosensitive-recording layer 14 are subjected to image recording to form coloring layers, whereas cyan thermosensitive-recording layer 12 is left as a un-coloring layer without causing the image recording. Thereby, the smoothening treatment may be achieved without causing the color developing of the cyan thermosensitive-recording layer 12, color thermosensitive-recording paper 16 may be smoothened, and the interface between support 11 and cyan thermosensitive-recording layer 12 may also be smoothened. In the secondary image recording, cyan thermosensitive-recording layer 12 adjacent to support 11 is subjected to color developing after the surface of support 11 is smoothened, consequently the concentration nonuniformity of cyan thermosensitive-recording layer 12 is controlled at the image recording surface, images may be produced with high gloss and high quality.

In addition, only the yellow thermosensitive-recording layer 14 may be subjected to image recording to form a coloring layer, whereas cyan thermosensitive-recording layer 12 and magenta thermosensitive-recording layer 13 may be remained as un-coloring layers without subjecting to image recording. Smoothening the thermosensitive-recording material i.e. the smoothening treatment is carried out without image recording of cyan thermosensitive-recording layer 12 and magenta thermosensitive-recording layer 13; therefore, color thermosensitive-recording paper 16 may be smoothened, the interface between support 11 and cyan thermosensitive-recording layer 12 as well as the interface between cyan thermosensitive-recording layer 12 and magenta thermosensitive-recording layer 13 may be smoothened.

In the secondary image recording, cyan thermosensitive-recording layer 12, being most susceptible to the effect of surface configuration of support 11, is subjected to image recording after the surface of support 11 is smoothened; magenta thermosensitive-recording layer 13, is subjected to image recording after the surface of support 11 is smoothened and also the interface between cyan thermosensitive-recording layer 12 and magenta thermosensitive-recording layer 13 is smoothened; consequently the concentration nonuniformity of cyan thermosensitive-recording layer 12 and magenta thermosensitive-recording layer 13 is controlled at their image recording surfaces, and images may be produced with high gloss and high quality.

In the third aspect of the thermosensitive-recording process according to the present invention, the smoothening treatment i.e. smoothening the thermosensitive-recording material is carried out on the recorded thermosensitive-recording material. Thereby, the concentration nonuniformity may be reduced, and images may be obtained with higher gloss and higher quality, even though the images prior to the smoothening treatment is of relatively inferior concentration nonuniformity and relatively low gloss.

The thermosensitive-recording layer comprises at least a coloring component, and other components depending on the requirements.

Coloring Component

The coloring component may be properly selected depending on the application; preferably the coloring component comprises two components, that is, coloring component A and coloring component B; and a color is developed by reaction of coloring components A and B. In such a case, the thermosensitive-recording layer is classified as a two-component thermosensitive-recording layer.

The color developed by the coloring components may be properly selected depending on the application; preferably the color is substantially colorless. Preferably, the coloring component is encapsulated in microcapsule.

Examples of the combination of the coloring component A and the coloring component B include the following combinations:
(a) combination of an electron-donating-dye precursor and an electron-accepting compound;
(b) combination of a photodecomposable diazo compound and a coupler compound;
(c) combination of a metal salt of an organic acid, such as silver behenate or silver stearate, and a reducing agent such as protocatechinic acid, spiroindan, or hydroquinone;
(d) combination of an iron salt of a long-chain fatty acid, such as ferric stearate or ferric myristate, and a phenol such as gallic acid, or ammonium salicylate;
(e) combination of a heavy metal salt of an organic acid, such as a nickel, cobalt, lead, copper, iron, mercury, or silver salt of acetic acid, stearic acid, or palmitic acid, and a sulfide of an alkali metal or an alkaline earth metal, such as calcium sulfide, strontium sulfide, or potassium sulfide, or a combination of the above-described heavy metal salt of an organic acid and an organic chelating agent such as s-diphenylcarbazide or diphenylcarbazone;
(f) combination of a heavy metal sulfate, such as a silver, lead, mercury, or sodium salt of sulfuric acid, and a sulfur compound such as sodium tetrathionate, sodium thiosulfate, or thiourea;
(g) combination of a ferric salt of a fatty acid, such as ferric stearate, and an aromatic polyhydroxy compound such as 3,4-hydroxytetraphenyl methane;
(h) combination of a metal salt of an organic acid, such as silver oxalate or mercury oxalate, and an organic polyhydroxy compound such as polyhydroxy alcohol, glycerin, or glycol;
(i) combination of a ferric salt of a fatty acid, such as ferric pelargonate or ferric laurate, and a thiocesylcarbamide or isothiocesylcarbamide derivative;
(j) combination of a lead salt of an organic acid, such as lead capronate, lead pelargonate, or lead behenate, and a thiourea derivative such as ethylene thiourea or N-dodecyl thiourea;
(k) combination of a heavy metal salt of a higher fatty acid, such as ferric stearate or copper stearate, and zinc dialkyldithiocarbamate;
(l) combination capable of forming an oxazine dye such as a combination of resorcinol and a nitroso compound;
(m) combination of a formazan compound and a reducing agent and/or a metal salt;
(n) combination of a protected dye (or a leuco dye) precursor and a protector-removing agent;
(o) combination of an oxidation-type color-forming agent and an oxidizing agent;
(p) combination of a phthalonitrile and a diiminoisoindoline (i.e., a combination that forms phthalocyanine);
(q) combination of an isocyanate and a diiminoisoindoline (i.e., a combination that forms a coloring pigment);
(r) combination of a pigment precursor and an acid or base (i.e., a combination that forms a pigment).

Among these, (a) combination of an electron-donating-dye precursor and an electron-accepting compound; (b) combination of a photodecomposable diazo compound and a coupler compound; and the like are particular preferable.

In the thermosensitive-recording material, the thermosensitive-recording layer is preferably constituted such that the haze value, which is obtained from the following calculation:
(diffused light transmittance)÷(total light transmittance)×100(%),
exhibits lower level, thereby an image with superior transparency may be produced. The haze value is an index showing the transparency of a material and is typically calculated from the total light transmittance, the diffused light transmittance and the specular light transmittance measured by a haze meter.

As for the method to reduce the haze value, the followings are exemplified: (1) 50% volume-averaged particle sizes of coloring components A and B are controlled preferably to 1.0 μm or less, more preferably to 0.6 μm or less, and a binder is incorporated in an amount of 30 to 60% by mass based on total solid components in the thermosensitive-recording layer; (2) one of the coloring components A and B is micro-encapsulated and the other is used in a form which forms a substantially continuous layer after application and drying, for example, is used in the form of an emulsion; and (3) the refractivity indices of the components used in the thermosensitive-recording layer are adjusted to be as close to a specific value as possible.

The combinations of (a) and (b), which are preferably employed in the thermosensitive-recording layer, will be explained in detail hereinafter.

At first, the coloring component will be discussed as to (a) combination of an electron-donating-dye precursor and an electron-accepting compound. The electron-donating-dye precursor may be properly selected without particular limitation as long as it is substantially colorless. The electron-donating-dye precursor is a compound having a property to develop color by donating an electron or by accepting a proton from an acid or the like. Among various compounds, such colorless compound is preferable as having a partial skeleton structure of lactone, lactum, sultone, spiropyran, ester or amide which cause open ring or cleavage of the structure when the compound is brought into contact with an electron-accepting compound.

Electron-Donating-Dye Precursor

Examples of the electron-donating-dye precursor include triphenylmethane phthalide compounds, fluoran compounds, phenothiazine compounds, indolyl phthalide compounds, leuko auramine compounds, rhodamine lactum compounds, triphenylmethane compounds, triazine compounds, spiropyran compounds, fluorene compounds, pyridine compounds and pyrazine compounds. These compounds may be used alone or in combination.

The triphenylmethane phthalide compounds are exemplified in re-issued U.S. Pat. No. 23,024, and U.S. Pat. No. 3,491,111, No. 3,491,112, No. 3,491,116, and No. 3,509,174.

The fluoran compounds are exemplified U.S. Pat. No. 3,624,107, No. 3,627,787, No. 3,641,011, No. 3,462,828, No. 3,681,390, No. 3,920,510, and No. 3,959,571.

Examples of the spiropyran compound include the compounds described in, for example, U.S. Pat. No. 3,971,808. Specific examples thereof include 3-methyl-spiro-dinaphthopyran, 3-ethyl-spiro-dinaphthopyran, 3,3′-dichloro-spiro-dinaphthopyran, 3-benzylspiro-dinaphthopyran, 3-methyl-naphto-(3-methoxybenzo)spiropyran, 3-propyl-spiro-dibenzopyran, and the like. These may be used alone or in combination.

Examples of the pyridine-based compound and pyrazine-based compound include the compounds described in, for example, U.S. Pat. No. 3,775,424, No. 3,853,869, and No. 4,246,318.

Examples of the fluorene compound include the compounds described in, for example, JP-A No. 63-094878.

Specific examples thereof include
2-anilino-3-methyl-6-diethylaminofluoran,
2-anilino-3-methyl-6-N-cyclohexyl-N-methylaminofluoran,
2-p-chloroanilino-3-methyl-6-dibutylaminofluoran,
2-anilino-3-chloro-6-diethylaminofluoran,
2-anilino-3-methyl-6N-ethyl-N-isoamylaminofluoran,
2-anilino-3-methyl-6-N-ethyl-N-dodecylaminofluoran,
2-anilino-3-methoxy-6-dibutylaminofluoran,
2-p-chloroanilino-3-ethyl-6-N-ethyl-N-isoamylaminofluoran,
2-o-chloroanilino-6-p-butylanilinofluoran,
2-anilino-3-pentadecyl-6-diethylaminofluoran,
2-anilino-3-ethyl-6-dibutylaminofluoran,
2-o-toluidino-3-methyl-6-diisopropylaminofluoran,
2-anilino-3-methyl-6-N-isobutyl-N-ethylaminofluoran,
2-anilino-3-methyl-6-N-ethyl-N-tetrahydrofurfurylaminofluoran,
2-anilino-3-chloro-6-N-ethyl-N-isoamylaminofluoran,
2-anilino-3-methyl-6-N-methyl-N-γ-ethoxypropylaminofluoran,
2-anilino-3-methyl-6-N-ethyl-N-γ-ethoxypropylaminofluoran and
2-anilino-3-methyl-6-N-ethyl-N-γ-propoxypropylaminofluoran.
   These compounds may be uses alone or in combination.
   Electron-Accepting Compound

The electron-accepting compounds may be selected from conventional compounds such as phenol derivatives, salicylic acid derivatives, metal salts of aromatic carboxylic acids, acid clay, bentonite, novolak resins, metal-treated novolak resins, and metal complexes. Examples of these compounds are described, for example, in Japanese Patent Application Publication (JP-B) No. 40-9309, JP-B No. 45-14039, JP-A No. 52-140483, JP-A No. 48-51510, JP-A No. 57-210886, JP-A No. 58-87089, JP-A No. 59-11286, JP-A No. 60-176795 and JP-A No. 61-95988.

Examples of the phenol derivative include
2,2′-bis(4-hydroxyphenol)propane, 4-t-butylphenol, 4-phenylphenol, 4-hydroxydiphenoxide, 1,1′-bis(4-hydroxyphenyl)cyclohexane, 1,1′-bis(3-chloro-4-hydroxyphenyl)cyclohexane, 1,1′-bis(3-chloro-4-hydroxyphenyl)-2-ethylbutane, 4,4′-sec-isooctylidenediphenol, 4,4′-sec-butyrylene diphenol, 4-tert-octylphenol, 4-p-methyphenylphenol, 4,4′-methylcyclohexylidenephenol, 4,4′-isopentylidenephenol, and p-hydroxybenzyl benzoate. These may be used alone or in combination.

Examples of the salicylic acid derivative include
4-pentadecylsalicylic acid, 3-5-di(α-methylbenzyl)salicylic acid, 3,5-di(tert-octyl)salicylic acid, 5-octadecylsalicylic acid, 5-α-(p-α-methylbenzylphenyl)ethylsalicylic acid, 3-α-methylbenzyl-5-tert-octylsalicylic acid, 5-tetradecylsalicylic acid, 4-hexyloxysalicylic acid, 4-cyclohexyloxysalicylic acid, 4-decyloxysalicylic acid, 4-dodecyloxysalicylic acid, 4-pentadecyloxysalicylic acid, 4-octadecyloxysalicylic acid, and zinc, aluminum, calcium, copper, and lead salt thereof. These may be used alone or in combination.

When the combination of electron-donating-dye precursor and electron-accepting compound is employed as the coloring component, the content of electron-donating-dye precursor in the thermosensitive-recording layer is preferably 0.1 to 5 g/m², more preferably is 0.1 to 1 g/m². Further, the content of electron-accepting compound in the thermosensitive-recording layer is preferably 0.5 to 20 parts by mass, more preferably 3 to 10 parts by mass based on one part of the electron-donating-dye precursor. When the content of electron-accepting compound is less than 0.5 parts by mass, the coloring density may not be sufficient, when it is over 20 parts by mass, the sensitivity is likely to decrease, resulting in inferior coating performance.

Diazo Compound

The diazo compound may be properly selected depending on the application, for example the compounds expressed by formula (1) below are preferred.

The diazo compound displays a coupling reaction with a coupler as coupling component discussed later to perform image recording in a desired hue. When a light of specific wavelength is irradiated onto the diazo compound before the coupling reaction, the diazo compound decomposes and loses the ability to develop color even in the presence of the coupling component.

The color hue of this coloring system is decided by the diazo dye produced by reaction of the diazo compound with the coupler. Therefore, the developed hue may be changed easily by altering the chemical structure of the diazo compound or the coupler. Thus, a desired hue may be obtained by selecting a suitable combination of the diazo compound and the coupler.
Ar—N₂⁺.Y⁻ Formula (1)
wherein “Ar” represents a substituted or unsubstituted aromatic hydrocarbon ring group, “Y⁻” represents an acid anion.

Examples of the substituent include alkyl groups, alkoxy groups, alkylthio groups, aryl groups, aryloxy groups, arylthio groups, acyl groups, alkoxycarbonyl groups, carbamoyl groups, carboamide groups, sulfonyl groups, sulfamoyl groups, sulfone amid groups, ureide groups, halogen groups, amino groups and heterocyclic groups. These substituents may be further substituted.

As for the aromatic hydrocarbon group, aryl groups having 6 to 30 carbon atoms are preferred; examples thereof include phenyl group, 2-methylphenyl group, 2-chlorophenyl group, 2-methoxyphenyl group, 2-butoxyphenyl group, 2-(2-ethylhexyloxy)phenyl group, 2-octyloxyphenyl group, 3-(2,4-di-t-pentylphenoxyethoxy)phenyl group, 4-chlorophenyl group, 2,5-dichlorophenyl group, 2,4,6-trimethylphenyl group, 3-chlorophenyl group, 3-methylphenyl group, 3-methoxyphenyl group, 3-butoxyphenyl group, 3-cyanophenyl group, 3-(2-ethylhexyloxy)phenyl group, 3,4-dichlorophenyl group, 3,5-dichlorophenyl group, 3,4-dimethoxyphenyl group, 3-(dibutylaminocarbonylmethoxy)phenyl group, 4-cyanophenyl group, 4-methylphenyl group, 4-methoxyphenyl group, 4-butoxyphenyl group, 4-(2-ethylhexyloxy)phenyl group, 4-benzylphenyl group, 4-aminosulfonylphenyl group, 4-N,N-dibutylaminosulfonylphenyl group, 4-ethoxycarbonylphenyl group, 4-(2-ethylhexylcarbonyl)phenyl group, 4-fluorophenyl group, 3-acetylphenyl group, 2-acetylaminophenyl group, 4-(4-chlorophenylthio)phenyl group, 4-(4-methylphenyl)thio-2,5-butoxyphenyl group, and 4-(N-benzyl-N-methylamino)-2-dodecyloxycarbonylphenyl group. The aryl group is not limited to these examples. In addition, each of these groups may be further substituted by alkyloxy group, alkylthio group, substituted phenyl group, cyano group, substituted amino group, halogen atom, heterocyclic group, or the like.

Examples of the diazo compound suitably include also the diazo compounds listed in JP-A No. 7-276808, paragraphs 44 to 49.

The maximum absorption wavelength λₘₐₓ of the diazo compound is preferably 450 nm or less and more preferably 290 to 440 nm.

In addition, it is desirable that the diazo compound is of 12 or more carbon atoms, solubility in water of 1% or less, and solubility in ethyl acetate of 5% or more. These diazo compounds may be used alone or in combination with respect to additional adjustment of hue.

Coupler Compound

The coupler compound may be properly selected depending on the application, provided that the coupler forms a coloring agent by coupling reaction with a diazo compound; so-called active methylene compound having a methylene group adjacent to a carbonyl group, phenol derivative, and naphthol derivative may be exemplified. Specific examples of the coupler include resorcins, phloroglucins, 2,3-dihydroxynaphthalene, sodium 2,3-dihydroxynaphthalene-6-sulfonate, 1-hydroxy-2-naphthoic morpholinopropylamide, sodium 2-hydroxy-3-naphthalenesulfonate, 2-hydroxy-3-naphthalenesulfonic anilide, 2-hydroxy-3-naphthalenesolfonic morpholinopropylamides, 2-hydroxy-3-naphthalenesulfonate-2-ethylhexyloxypropylamide, 2-hydroxy-3-naphthalenesulfonate-2-ethylhexylamide, 5-acetamide-1-naphthol, sodium 1-hydroxy-8-acetamidenaphthalene-3,6-disulfonate, 1-hydroxy-8-acetamidenaphthalene-3,6-disulfonic dianilide, 1,5-dihydroxynaphthalene, 2-hydroxy-3-naphthoic morpholinopropylamide, 2-hydroxy-3-naphthoic octylamide, 2-hydroxy-3-naphthoic anilide, 5,5-dimethyl-1,3-cyclohexanedion, 1,3-cyclopentanedion, 5-(2-n-tetradecyloxyphenyl)-1,3-cyclohexanedion, 5-phenyl-4-methoxycarbonyl-1,3-cyclohexanedion, 5-(2,5-di-n-octyloxyphenyl)-1,3-cyclohexanedion, N,N′-dicyclohexyl barbituric acid, N,N′-di-n-dodecyl barbituric acid, N-n-octyl-N′-n-octadecyl barbituric acid, N-phenyl-N′-(2,5-di-n-octyloxyphenyl)barbituric acid, N,N′-bis(octadecyloxycarbonylmethyl)barbituric acid, 1-phenyl-3-methyl-5-pyrazolone, 1-(2,4,6-trichlorophenyl)-3-anilino-5-pyrazolone, 1-(2,4,6-trichlorophenyl)-3-benzamide-5-pyrazolone, 6-hydroxy-4-methyl-3-cyano-1-(2-ethylhexyl)-2-pyridone, 2,4-bis-(benzoylacetamide)toluene, 1,3-bis-(pivaloylacetamidemethyl)benzene, benzoylacetonitrile, thenoylacetonitrile, acetoacetoanilide, benzoylacetoanilide, pivaloylacetoanilide, 2-chloro-5-(N-n-butylsulfamoyl)-l-pivaloylacetamidebenzene, 1-(2-ethylhexyloxypropyl)-3-cyano-4-methyl-6-hydroxy-1,2-dihydro pyridine-2-on, 1-(dodecyloxypropyl)-3-acetyl-4-methyl-6-hydroxy-1,2-dihydropyri dine-2-on, and 1-(4-n-octyloxyphenyl)-3-tert-butyl-5-aminopyrazole. These may be used alone or in combination.

The detail of the coupler compounds is disclosed in JP-A No. 4-201483, No. 7-223367, No. 7-223368, No. 7-323660, No. 5-278608, No. 5-297024, No. 6-18669, No. 6-18670, No. 7-316280, No. 9-216468, No. 9-216469, No. 9-319025, No. 10-035113, No. 10-193801, and No. 10-264532.

When the diazo compound and the coupler compound are employed as the coloring component, the content of the diazo compound in the thermosensitive-recording layer is preferably 0.02 to 5.0 g/m², and more preferably 0.05 to 3.0 g/m². The content of the coupler compound in the thermosensitive-recording layer is preferably 0.5 to 20 parts by mass, more preferably 3 to 10 parts by mass based on the utilized diazo compound. When the content of the coupler is less than 0.5 parts by mass, the coloring ability tends to be insufficient, when over 20 parts by mass, the coating performance is often not preferable.

As for the method to make use of the coupler compound with optional other components, such methods may be exemplified as dispersing the coupler compound in solid-state together with other components in the presence of a water-soluble polymer in a sand mill or the like, or emulsifying the coupler compound in the presence of suitable emulsifying aid and utilizing as an emulsion. The method of solid-state dispersing or the emulsifying is not particularly limited, and conventional art may be employed. The details are described in JP-A No. 59-190886, No. 2-141279, and No. 7-17145.

Other Components

The other components may be properly selected depending on the application; organic base, coloring aid, binder, antifoaming agent, fluorescent dye, coloring dye, inorganic pigment, wax, higher fatty acid amide, metal soap, ultraviolet absorbent, antioxidant, and latex binder may be exemplified.

The organic base may be added in order to accelerate the coupling reaction between the diazo compound and the coupler; examples thereof include tertiary amines, piperidines, piperazines, amidines, formamidines, pyridines, guanidines, morpholines, or the like.

Examples of the piperidine include
N-(3-phenoxy-2-hydroxypropyl)piperidine, N-dodecylpiperidine, and the like.

Example of the piperazine include
N,N′-bis(3-phenoxy-2-hydroxypropyl)piperazine, N,N′-bis[3-(p-methylphenoxy)-2-hydroxypropyl]piperazine, N,N′-bis[3-(p-methoxyphenoxy)-2-hydroxypropyl]piperazine, N,N′-bis(3-phenylthio-2-hydroxypropyl)piperazine, N,N′-bis[3-(β-naphthoxy)-2-hydroxypropyl]piperazine, N-3-(β-naphthoxy)-2-hydroxypropyl-N′-methylpiperazine, 1,4-bis{[3-(N-methylpiperazino)-2-hydroxy]propyloxy}benzene, and the like. These may be used alone or in combination.

Examples of the guanidine include triphenylguanidines, tricyclohexylguanidines and dicyclohexylphenylguanidines.

Examples of the morpholine include
N-[3-(β-naphthoxy)-2-hydroxy]propylmorpholine, 1,4-bis(3-morpholino-2-hydroxypropyloxy)benzene and 1,3-bis(3-morpholino-2-hydroxypropyloxy)benzene.

These organic base may be used alone, alternatively may be used in combination of different compound types.

The organic bases are also described in JP-A No. 58-031385, No. 61-209876, No.9-071048, No. 9-077729, and No. 9-077737.

The available amount of the organic base may be properly selected depending on the application; for example the organic base is preferably employed 1 to 30 moles based on one mol of diazo compound.

The coloring aid is employed for the purpose of promoting the image recording reaction. Examples thereof include phenol derivatives, naphthol derivatives, alkoxy substituted benzenes, alkoxy substituted naphthalenes, hydroxy compounds, amide carboxylate compounds, sulfonamide compounds, and the like.

Examples of the binder include polyvinyl alcohols, hydroxyethyl celluloses, hydroxypropyl celluloses, ethylene-maleic anhydride copolymers, styrene-maleic anhydride copolymers, isobutylene-maleic anhydride copolymers, polyacrylic acids, starch derivatives, casein, gelatin, and the like.

The content of the binder in the thermosensitive-recording layer may be properly selected, for example, is preferably 10 to 30% by mass as dried mass amount.

Further, for the purpose to enhance the waterproof ability of binder, a waterproofing agent (gelling agent or crosslinking agent) may be added. As for the waterproofing agent, hydrophobic polymer emulsion such as styrene-butadiene rubber latex, acrylic resin emulsion or the like may be exemplified.

The additives may be reviewed in the disclosure of JP-A No. 60-125470, No. 60-125471, No. 60-125472, No. 60-287485, No. 60-287486, No. 60-287487, No. 62-146680, No. 60-287488, No. 62-282885, No. 63-89877, No. 63-88380, No. 63-088381, No. 01-239282, No. 04-291685, No. 04-291684, No. 05-188687, No. 05-188686, No. 05-110490, No. 05-1108437, No. 05-170361, No. 63-203372, No. 63-224989, No. 63-267594, No. 63-182484, No. 60-107384, No. 60-107383, No. 61-160287, No. 61-185483, No. 61-211079, No. 63-251282, and No. 63-051174, JP-B No. 48-043294 and No. 48-033212, etc.

In order to record an image on the thermosensitive-recording layer through applying heat and/or pressure, it is preferred that the responsibility against heat and/or pressure is imparted to the coloring reaction of the coloring components. For example, the coloring reaction may response heat through encapsulating one of the coloring components into thermo-responsible microcapsules. The method to encapsulate a coloring component into microcapsules may be selected based conventional art, for example, a method utilizing coacervation of a hydrophilic wall-forming material described in U.S. Pat. No. 2,800,457 and No. 2,800,458; an interfacial polymerization method described in U.S. Pat. No. 3,287,154, U.K. Pat. No. 990,443, and JP-B No. 38-19574, No. 42-446, and No. 42-771; a method utilizing polymer deposition described in U.S. Pat. No. 3,418,250 and No. 3,660,304; a method utilizing an isocyanate-polyol wall forming material described in U.S. Pat. No. 3,796,669; a method utilizing an isocyanate wall forming material described in U.S. Pat. No. 3,914,511; a method utilizing urea-formaldehyde and urea-formaldehyde-resorcinol wall-forming materials described in U.S. Pat. No. 4,001,140, No. 4,087,376, and No. 4,089,802; a method utilizing wall-forming materials such as a melamine-formaldehyde resin and hydroxypropylcellulose described in U.S. Pat. No. 4,025,455; an in-situ method utilizing a polymerization of monomers described in JP-B No. 36-9168 and JP-A No. 51-9079; a method utilizing electrolytic dispersion cooling described in U.K. Pat. Nos. 952,807 and 965,074; and a spray-drying method described in U.S. Pat. No. 3,111,407 and U.K. Pat. No. 930,422.

As for a preferable method to encapsulate a coloring component into microcapsules, the following interface polymerization method is exemplified: one of coloring component, e.g. the electron-donating-dye precursor in aforesaid combination (a) or the diazo compound in aforesaid combination (b), is dissolved or dispersed in a hydrophilic organic solvent that is intended to become the core of the capsules thereby to prepare an oil phase, the resulting oil phase is mixed with a water phase dissolving a water-soluble polymer, the mixture is emulsified by means of a homogenizer or the like, then the emulsion is heated to cause a polymer-forming reaction at the interface of droplets so that polymeric microcapsule walls are formed.

This method makes it possible to form capsules having uniform particle diameters in a short period of time and to obtain a recording material excellent in storability as a raw recording material.

The reactant that forms the polymeric material may be added to the inside of the droplets and/or the outside of the droplets. Examples of the polymeric substance include polyurethanes, polyureas, polyamides, polyesters, polycarbonates, urea/formaldehyde resins, melamine resins, polystyrenes, styrene/methacrylate copolymers, styrene/acrylate copolymers, and the like. Among these substances, polyurethanes, polyureas, polyamides, polyesters, and polycarbonates are preferable, and polyurethanes and polyureas are particularly preferable. These polymeric substances may be used alone or in combination.

Examples of the water-soluble polymer include gelatin, polyvinyl pyrrolidone, polyvinyl alcohol, and the like. For example, when polyurethane is used as capsule wall material, the microcapsule wall may be formed by mixing a polyvalent isocyanate and a second substance (e.g., polyol or polyamine) that reacts therewith to form the capsule wall in a water-soluble polymer solution (i.e., aqueous phase) or in an oily medium (oil phase) to be encapsulated, emulsifying the mixture, and heating the resulting emulsion so as to cause a polymer-forming reaction at the interface of droplets. The particle size of the microcapsules is preferably 0.1 to 1.0 μm, more preferably 0.2 to 0.7 μm.

As for the other method to impart thermo-responsibility to the coloring reaction, one of coloring component (e.g. the electron-accepting compound in aforesaid combination (a) or the coupler compound in aforesaid combination (b), hereinafter referring to “color developer”) is compounded with thermo-melting material with lower melting point, then the coloring component is incorporated in the thermosensitive-recording layer as the eutectic material, alternatively the coloring component is incorporated in the thermosensitive-recording layer in a condition that the material with lower melting point is fused to the surface of the color developer particles.

Examples of the material with lower melting point include wases such as paraffin wax, carnauba wax, microcrystalline wax, and polyethylene wax; higher fatty acid amides such as amide stearate, ethylene bisstearoamide; and higher fatty acid esters, and the like. These may be used alone or in combination.

The method for forming thermosensitive-recording layer may be properly selected depending on the application; for example such a method is exemplified as applying a coating liquid, which dissolve or disperse a coloring component and the like, on a support, and drying the liquid.

Example of the coating method of the coating liquid include blade coating, air knife coating, gravure coating, roll coating, spray coating, dip coating, bar coating, extrusion coating, spin coating or the like.

The coated amount of the coating liquid may be properly selected depending on the application; usually 3 to 15 g/m² is preferable, and 4 to 10 g/m² is more preferable as the mass amount after drying.

[Other Layers]

As for the other layers, protective layer, reflective layer, undercoat layer and the like may be exemplified.

The protective layer preferably contains a polymer of which the second-order transition temperature is 60° C. or more and of which the melting point is 250° C. or more. Such polymer is polyvinyl alcohol for example. The position to form the protective layer is preferably the outermost surface, for example, as protective layer 15 in FIG. 1.

Image Recording

The method for image recording may be properly selected under the condition that images are formed through heating treatment, and may carried out by means of a known printer selected depending on the purpose.

The heating treatment may be properly selected depending on the application, for example, heating treatment by means of a thermal head may be possible.

The thermal head is preferably of the configuration comprising a number of heating elements disposed in parallel in a direction perpendicular to the conveying direction of the thermosensitive-recording material.

In the case that the thermosensitive-recording layer of the thermosensitive-recording material is laminated as shown in FIG. 1, microcapsules are prepared such that yellow thermosensitive-recording layer 14 undergoes image recording at the lowest thermal energy, and cyan thermosensitive-recording layer 12 undergoes image recording at the highest thermal energy, therefore yellow thermosensitive-recording layer 14 may be subjected to image recording through supplying the corresponding low thermal energy from the heating element array to yellow thermosensitive-recording layer 14.

<Smoothening Treatment>

In the smoothening treatment, the image recording surface of the thermosensitive-recording material is subjected to smoothening treatment, i.e. the thermosensitive-recording material is smoothened, the smoothening treatment is carried out at least before recording the image in the first aspect, at least while recording the image in the second aspect, and at least after recording the image in the third aspect.

By the way, when a portion of thermosensitive-recording layer that did not undergo image recording (un-coloring layer) prior to the smoothening treatment, preferably, the smoothening treatment is carried out without conducting the image recording of the thermosensitive-layer.

The smoothening treatment may be carried out by a properly selected method depending on the application such as by a pair of rollers, belt and roller, or the like.

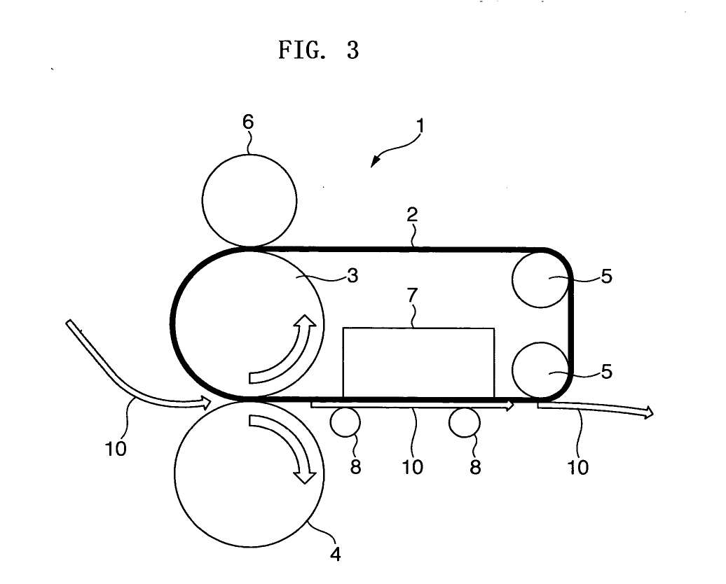

The belt and roller may be properly selected depending on the application; for example the belt and roller may be of the belt-type smoothening device 1 as shown in FIG. 3. The belt-type smoothening device 1 is equipped with belt 2, heating roller 3, pressure roller 4, tension rollers 5, cleaning roller 6, and conveying roller 8. The heating roller 3 and a pair of the tension rollers 5 are arranged inside the belt 2. The belt 2 is rotatably spanned among heating roller 3 and a pair of tension rollers 5 disposed separately from heating roller3. The pressure roller 4 is arranged in contact with the belt 2 and faces the heating roller 3. A portion between the pressure roller 4 and the belt 2 is pressurized by pressure roller 4 and the heating roller 3 to thereby form a nip.

In the smoothening treatment, preferably, the image recording surface of the thermosensitive-recording material is made contact with the surface of the belt member, the smoothening treatment is carried out through heating and pressing the thermosensitive-recording material, and the thermosensitive-recording material is separated from the belt member after cooling the thermosensitive-recording material.

The heating temperature in the smoothening treatment and conveying velocity of the thermosensitive-recording material are properly selected depending on the application; preferably the heating temperature is above 70° C. and below 170° C., and the conveying velocity is 1 to 200 mm/sec, more preferably, the heating temperature is 75 to 165° C., and the conveying velocity is 1 to 50 mm/sec, still more preferably, the heating temperature is 80° C. to 150° C., and the conveying velocity is 10 to 50 mm/sec.

When the conveying velocity is less than 1 mm/sec, the blistering may occur, and when the conveying velocity is above 50 mm/sec, the surface smoothness may be insufficient.

When the heating temperature is 70° C. or less, the blistering may occur unless the conveying velocity is lowered, when the heating temperature is 170° C. or more, the surface smoothness may not be sufficiently uniform.

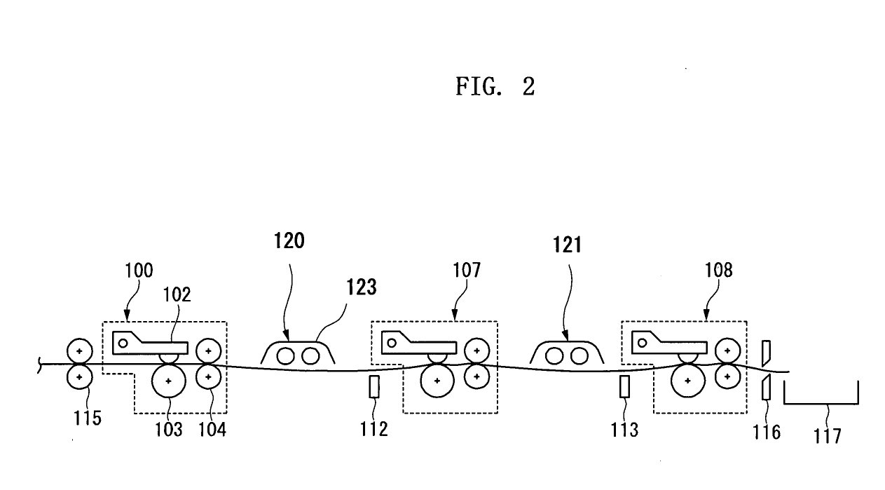

The second aspect of the image recording process according to the present invention will be exemplarily explained referring to FIGS. 1 and 2 in the following.

When yellow thermosensitive-recording layer 14 and magenta thermosensitive-recording layer 13 are intended to undergo coloring, and cyan thermosensitive-recording layer 12 is intended to remain un-coloring, in the primary image recording as shown in FIGS. 1 and 2, color thermosensitive-recording paper 16 is conveyed to yellow recording unit 100 and heated by thermal head 102, thereby yellow thermosensitive-recording layer 14 undergoes coloring. Then color thermosensitive-recording paper 16 is conveyed to the Y-layer fixing lump 120 and is fixed by means of the Y-layer fixing lump 120. In the Y-layer fixing, yellow thermosensitive-recording layer 14 is fixed through irradiating near-UV rays of 420 nm after printing a yellow image, in order not to cause image recording of the un-coloring component remained in yellow thermosensitive-recording layer 14 while recording magenta thermosensitive-recording layer 13. Then color thermosensitive-recording paper 16 is conveyed to magenta recording unit 107, and magenta thermosensitive-recording layer 13 undergoes image recording through heating by the thermal head in magenta recording unit 107. Then color thermosensitive-recording paper 16 is conveyed to M-layer recording lump 121, and fixed by means of M-layer recording lump 121 as M-layer fixing. In M-layer fixing, magenta thermosensitive-recording layer 13 is fixed through irradiating UV rays of 365 nm after recording magenta thermosensitive-recording layer 13.

Regarding reference numerals in FIG. 2, 103 represents a supporting roller, 104 represents a pair of conveying rollers, 112 and 113 represent slack sensors, 115 represents a pair of paper feeding rollers, 116 represents a cutter, 117 represents a discharged paper tray, and 123 represents a reflecting plate.

Then the interface between support 11 and cyan thermosensitive-recording layer 12 is smoothened in particular through the smoothening treatment (not shown), at this stage cyan thermosensitive-recording layer 12 adjacent to support 11 is still un-coloring layer. The smoothening treatment is summarized as above.

Thereafter, color thermosensitive-recording paper 16 is conveyed to cyan recording unit 108, and cyan thermosensitive-recording layer 12 adjacent to support 11 undergoes image recording through heating by the thermal head.

As the result of image recording as such, the nonuniform concentration of image recorded surface may be suppressed, images may be formed with high gloss and high quality.

<Other Processing>

The other processing include fixing. The fixing may be carried out as explained earlier.

In accordance with the inventive thermosensitive-recording process, the image quality of recorded images such as gloss may be enhanced through controlling the occurrence of blistering and improving flatness. Further, in accordance with the inventive thermosensitive-recording process, image recording of full-color images may be carried out with high gloss and high quality without ununiform concentration of the recorded image surface.

(Thermosensitive-Recording Apparatus)

The thermosensitive-recording apparatus comprises an image recording unit, a smoothening treatment unit, and others depending on the requirements.

In accordance with the present invention, the smoothening treatment unit is provided at least before recording the image in the first aspect, at least while recording the image in the second aspect, and at least after recording the image in the third aspect; and the heating temperature at the smoothening treatment is above 70° C. and below 170° C.

<Image Recording Unit>

In the image recording unit, images are recorded through heating a thermosensitive-recording material comprising a thermosensitive-recording layer.

The image recording may be conducted by a properly selected way by means of a conventional printer and the like. In particular, the image recording unit preferably involves the primary image recording unit and the secondary image recording unit in the second aspect according to the present invention.

The second aspect of the image recording unit will be exemplarily explained referring to FIGS. 1 and 2 in the following.

When yellow thermosensitive-recording layer 14 and magenta thermosensitive-recording layer 13 are intended to undergo coloring, and cyan thermosensitive-recording layer 12 is intended to remain un-coloring as shown in FIGS. 1 and 2, color thermosensitive-recording paper 16 is conveyed to yellow recording unit 100 and heated by thermal head 102, thereby yellow thermosensitive-recording layer 14 undergoes coloring. Then color thermosensitive-recording paper 16 is conveyed to the Y-layer fixing lump 120 and is fixed by means of the Y-layer fixing lump 120. In the Y-layer fixing, yellow thermosensitive-recording layer 14 is fixed through irradiating near-UV rays of 420 nm after printing a yellow image, in order not to cause image recording of the un-coloring component remained in yellow thermosensitive-recording layer 14 while recording magenta thermosensitive-recording layer 13. Then color thermosensitive-recording paper 16 is conveyed to magenta recording unit 107, and magenta thermosensitive-recording layer 13 undergoes image recording through heating by means of the thermal head in magenta recording unit 107. Then color thermosensitive-recording paper 16 is conveyed to M-layer recording lump 121, and fixed by means of M-layer recording lump 121 as M-layer fixing. In M-layer fixing, magenta thermosensitive-recording layer 13 is fixed through irradiating UV rays of 365 nm after recording magenta thermosensitive-recording layer 13. The primary image recording unit is explained hereinbefore.

In addition, the secondary image recording unit will be exemplarily explained referring to FIGS. 1 and 2. Color thermosensitive-recording layer 16 is conveyed to cyan recording unit 108 and heated by the thermal head as shown in FIGS. 1 and 2, thereby cyan thermosensitive-recording layer 12 adjacent to support 11 undergoes image recording. The secondary image recording unit is explained hereinbefore.

The secondary image recording unit is a unit in which image recording is carried out through heating the thermosensitive-recording layer; the un-coloring layer, which has not been subjected to image recording in the primary image recording, may undergo image recording.

The constitution of the secondary image recording unit may be substantially the same with that of the primary image recording unit, alternatively the constitutions may be significantly different each other.

Since the secondary image recording unit is provided as the post treatment of the heating and pressing treatment, the thermosensitive-recording material may be smoothened, therefore, the nonuniform concentration of the thermosensitive-recording layer may be controlled, and images may be printed with high gloss and high quality.

<Smoothening Treatment Unit>

In the smoothening treatment unit, the thermosensitive-recording layer of the thermosensitive-recording layer is smoothened.

In the smoothening treatment unit of the first aspect, smoothening the thermosensitive-recording material is carried out before the thermosensitive-recording layer is subjected to image recording. In the smoothening treatment unit of the second aspect, the smoothening the thermosensitive-recording material is carried out while recording the image, and before the image recording of the thermosensitive-recording layer adjacent to the support. In the smoothening treatment unit of the third aspect, smoothening the thermosensitive-recording material is carried out after the thermosensitive-recording layer is subjected to image recording.

The smoothening treatment unit may be selected from those capable of smoothening the thermosensitive-recording layer; examples thereof include a pair of rollers, belt and roller, or the like.

By the way, in the smoothening treatment unit of the second aspect, it is preferred that the un-coloring layer that did not undergo image recording at the primary image recording unit is also not subjected to image recording.

The belt and roller is preferably of belt-type smoothening device. The belt-type smoothening device is equipped with a belt member, heating and pressuring unit, and cooling unit.

The belt member may be properly selected depending on the application; examples thereof include an endless belt formed from a material such as polyimide, electroplated nickel or aluminum.

Preferably, a thin film comprising at least one material selected from a silicone rubber, fluorinated rubber, silicone resin or fluorinated resin is coated on the surface of the fixing belt. In particular, it is preferred to provide a layer of fluorocarbon siloxane rubber of uniform thickness on the surface of the fixing belt, or provide a layer of silicone rubber of uniform thickness on the surface of the fixing belt and then provide a layer of fluorocarbon siloxane rubber on the surface of the silicone rubber.

As for the fluorocarbon siloxane rubber, such type is preferred that has at least one of perfluoroalkylether group and perfluoroalkyl group in the backbone.

As for the fluorocarbon siloxane rubber, a cured product of fluorocarbon siloxane rubber composition which contains the following components of (A) to (D) is preferable: (A) fluorocarbon polymer having a fluorocarbon siloxane expressed by the following formula (1) as its main component, and containing aliphatic unsaturated groups, (B) organopolysiloxane and/or fluorocarbon siloxane containing two or more ≡SiH groups in one molecule, wherein the content of the ≡SiH groups is 1 to 4 times of the aliphatic unsaturated groups in the fluorocarbon siloxane rubber, (C) filler, and (D) effective amount of catalyst.

The fluorocarbon polymer of aforesaid component (A) comprises a fluorocarbon siloxane containing a repeated unit expressed by the following formula (1) as its main ingredient, and also contains aliphatic unsaturated groups. 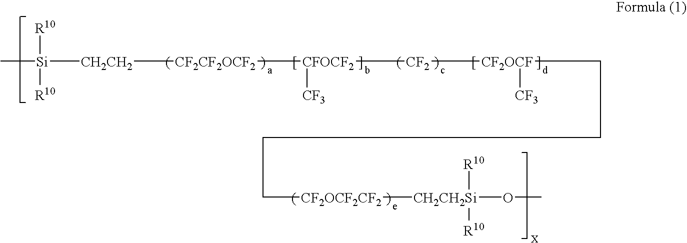
wherein, in the formula (1), R¹⁰ represents a non-substituted or substituted monofunctional hydrocarbon group containing preferably 1 to 8 carbon atoms, preferably an alkyl group containing 1 to 8 carbon atoms or an alkenyl group containing 2 to 3 carbon atoms, and particularly preferably a methyl group.

The “a” and “e” represent respectively an integer of 0 or 1. The “b” and “d” represent respectively an integer of 1 to 4. The “c” represents respectively an integer of 0 to 8. The “x” represents respectively an integer of 1 or more, preferably 10 to 30.

An example of such component (A) is a compound expressed by the following formula (2).

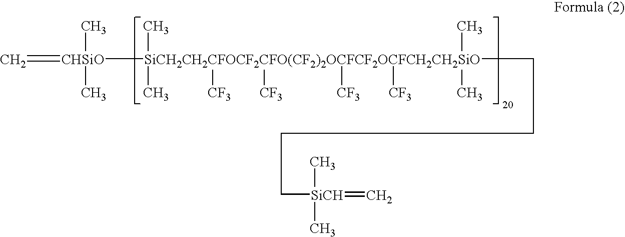

As for the component (B), an example of the organopolysiloxane comprising ≡SiH groups is organohydrogenpolysiloxane having at least two hydrogen atoms bonded to silicon atom in the molecule.

As for the fluorocarbon siloxane rubber composition, when the organocarbon polymer of component (A) comprises an aliphatic unsaturated group, the organohydrogenpolysiloxane may be preferably used as a curing agent. That is, the cured product is lo formed by an addition reaction between aliphatic unsaturated groups in the fluorocarbon siloxane, and hydrogen atoms bonded to silicon atoms in the organohydrogenpolysiloxane.

Examples of such organohydrogenpolysiloxane include the various organohydrogenpolysiloxanes used in an addition-curing type silicone rubber composition.

Preferably, the organohydrogenpolysiloxane is blended in such proportion that the number of “≡SiH groups” therein is at least one, and more preferably 1 to 5, relative to one aliphatic unsaturated hydrocarbon group in the fluorocarbon siloxane of component (A).

As for the fluorocarbon containing ≡SHi groups, R¹⁰ in the formula (1), as one unit or entire of the compound, is a dialkylhydrogensiloxane group, the terminal group is an ≡SiH group such as dialkylhydrogensiloxane group, silyl group and the like. An example of the fluorocarbon is that expressed by the following formula (3).

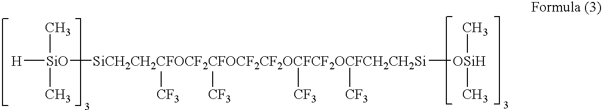

As for the filler of component (C), various fillers being utilized with conventional silicone rubbers may also be utilized. Examples of the filler include reinforcing fillers such as mist silica, precipitated silica, carbon powder, titanium dioxide, aluminum oxide, quartz powder, talc, sericite, bentonite and the like; and fiber fillers such as glass fiber, organic fibers and the like.

As for the catalyst of component (D), the catalysts known in the art as addition reaction catalyst may be exemplified such as chloroplatinic acid, alcohol-modified chloroplatinic acid, complexes of chloroplatinic acid and olefins, platinum black or palladium supported on a carrier as alumina, silica, carbon and the like, and Group VIII elements of the Periodic Table or compounds thereof such as complexes of rhodium and olefins, chlorotris(triphenylphosphine)rhodium (an Wilkinson catalyst), rhodium (III) acetyl acetonate and the like. These complexes are preferably utilized in a condition being dissolved in alcohol solvent, ether solvent, hydrocarbon solvent and the like.

The fluorocarbon siloxane rubber composition may be compounded various additives depending on the application. For example, dispersing agents such as diphenylsilane diol, hydroxy group terminated dimethylpolysiloxane of lower molecular weight, and hexamethyl disilazane; heat resistance improvers such as ferrous oxide, ferric oxide, cerium oxide, octyl acid iron, and the like; and colorants such as pigments or the like, may be compounded depending on the requirements.

The aforesaid belt member may be obtained by coating the surface of heat resistant support film with the fluorocarbon siloxane rubber composition, then heating and curing thereof. The composition may be diluted to form a coating solution with a solvent such as m-xylene hexafluoride, benzotrifluoride and the like. The temperature and period of the heating and curing may be suitably selected depending on the type of support film, process for manufacturing and the like, usually from the ranges of the 100° C. to 500° C. and 5 seconds to 5 hours.

The thickness of the fluorocarbon siloxane rubber coated on the surface of the belt member is preferably 20 to 500 μm, more preferably 40 to 200 μm.

The surface roughness of the belt member is preferably 20 μm or less, more preferably 5 μm or less, still more preferably 1 μm or less as arithmetic mean roughness (Ra) so as to form images with superior surface smoothness and excellent glossiness in particular.

The mean roughness may be measured based on JIS B 0601, JIS B 0651 and JIS B 0652.

The heating and pressuring unit is preferably a combination of a heating roller, pressure roller, and endless belt for example.

When such heating and pressuring unit is utilized, the resin layer is softened and deformed by the pressure. However, images with superior surface smoothness and excellent glossiness may be formed, provided that the heating and pressuring is carried out in the temperature range where the blistering may be avoided, cooling is conducted until the resin layer is solidified, then the separating is conducted from the belt member.

When the thermosensitive-recording material is brought into contact with the heating and pressing unit, heating and pressing are required. The pressing is preferably conducted by the application of nip pressure, but not limited to. The nip pressure is preferably from 1 to 100 kgf/cm² and more preferably form 5 to 30 kgf/cm² for the formation of images with excellent water resistance, high surface smoothness and good gloss.

The cooling unit may be properly selected depending on the application; examples thereof include a cooling heatsink.

The temperature of cooled thermosensitive-recording material prior to separating the thermosensitive-recording material from the belt member is preferably 80° C. or less where the polyolefin layer sufficiently solidifies, more preferably is 20 to 80° C., still more preferably is about room temperature 25° C.

As for the belt-type smoothening device, specifically, the device as shown in FIG. 3 may be exemplified.

In the belt-type smoothing device (endless press), processing section 1 is equipped with belt 2, heating roller, pressure roller 4, tension rollers 5, cleaning roller 6, cooling device 7, and conveying lo rollers 8.

Heating roller 3 and a pair of the tension rollers 5 are arranged inside the belt 2. Belt 2 is rotatably spanned among heating roller 3 and tension rollers 5 arranged distant from the heating roller 3. Pressure roller 4 is arranged in contact with belt 2 and faces heating roller 3. A portion between pressure roller 4 and belt 2 is pressurized by pressure roller 4 and heating roller 3 to thereby form a nip portion. Cooling device 7 is arranged inside the belt 2 between heating roller 3 and one of tension rollers 5. Heating roller 3 is disposed upstream in a rotating direction of belt 2, and one of the tension rollers 5 is disposed downstream thereof.

The two conveying rollers 8 are arranged so as to face the cooling device 7 with the interposition of belt 2. The distance between the two conveying rollers 8 is nearly equal to the distance between the nip and one of the conveying rollers 8 and the distance between the tension roller 5 and the other conveying roller 8. Cleaning roller 6 is arranged so as to face heating roller 3 with the interposition of the belt 2 in an opposite side to the pressure roller 4. The portion between cleaning roller 6 and belt 2 is pressurized by cleaning roller 6 and heating roller 3. Heating roller 3, pressure roller 4, tension rollers 5, cleaning roller 6, and conveying rollers 8 synchronously rotate to thereby allow the belt 2 to revolve.

In accordance with the inventive thermosensitive-recording apparatus, the occurrence of blistering is controlled, the flatness is improved, thereby image quality of the recorded images such as glossiness may be enhanced. Further, in accordance with the inventive thermosensitive-recording apparatus, printings of full-color images may be obtained with high gloss and high quality without significant ununiform concentration of the recorded image surface.

The present invention will be illustrated in more detailed with reference to examples given below, but these are not to be construed as limiting the invention. All percentages and parts are by weight unless indicated otherwise.

Preparation of Support A

A broadleaf kraft pulp (LBKP) was beaten to 300 ml (Canadian standard freeness, C.S.F.) by a disk refiner, and adjusted to a fiber length of 0.58 mm to prepare a pulp paper material. To the pulp paper material, 1.2% by mass of cationic starch, 0.5% by mass of alkyl ketene dimer (AKD), 0.3% by mass of anion polyacrylamide, 0.2% by mass of epoxidized fatty acid amide (EFA), and 0.3% by mass of Polyamide polyamine epichlorhydrin were added based on the mass of pulp.

Note: In the alkyl ketene dimer (AKD), the alkyl moiety is derived from fatty acids mainly containing behenic acid. In the epoxidized fatty acid amide (EFA), the fatty acid moiety is derived from fatty acids mainly containing behenic acid.

From the resulting pulp paper material, a raw paper of 150 g/m² was prepared by means of a Fortlinear paper machine. In addition, 1.0 g/m² of PVA (polyvinyl alcohol) and 0.8 g/m² of CaCl₂ were added on the way of drying in the Fortlinear paper machine by means of a size press device.

At the end of the paper preparation, the density was adjusted to 1.01 g/cm³ by means of a soft calender. The raw paper was conveyed in a condition that the side of the raw paper, on which the toner-image-receiving layer is to be provided, contacts with the metal roller. The surface temperature of the metal roller was 140° C. In the resulting raw paper, the whiteness level was 91%, the Oken type smoothness was 265 seconds, the Stökigt sizing degree was 127 seconds, the thickness was 100 μm.

After the raw paper was subjected to corona discharge on both the surfaces, polyethylene resin was coated on the raw paper by means of a melt extruder in an amount of 22 g/m² (36 μm thick) to form a rear layer of polyethylene resin. Then on the surface opposite to the surface (referring to “front surface”), on which the rear layer of polyethylene resin was previously formed, a polyethylene resin composition containing 10% by mass of anatase type titanium dioxide and a trace amount of ultramarine was coated in an amount of 35 g/m² (50 μm thick) to form a front layer of polyethylene resin.

On the rear layer of polyethylene resin, following corona discharge treatment, a mixture of aluminum oxide (Alumina Sol 100, by Nissan Chemical Industries, Ltd.) and silicon dioxide (Snowtex O, by Nissan Chemical Industries, Ltd.) in mass ration of 1:2 dispersed in water was applied as an antistatic agents in an amount of 0.2 g/m² as dried mass. As the result, support A was obtained.

Preparation of Support B

Support B was prepared in the same manner as Support A, except that the coated amount of the front layer of polyethylene resin was changed to 50 g/m², and the coated amount of the rear layer of polyethylene resin was changed to 31 g/m².

### EXAMPLE 1

<Preparation of Coating Liquid for Undercoat Layer>

12.85 parts by mass of acetoacetyl-denaturated polyvinyl alcohol (Gosefimer Z-210, by Nippon Synthetic Chemical Industry Co.,Ltd., saponification degree: 95 to 97%, polymerization degree: 1000) and 87.15 parts by mass of water were mixed, and were stirred at 90° C. or more to prepare a resin solution.

Then to a dispersion of an aqueous-swellable synthetic mica (SOMASHIF MEB-3, solid content: 8%, average particle size of mica: 2.0 μm, aspect ratio: 1000, by Co-op Chemical Co., Ltd.), de-ionized water was added in an amount that the mica content comes to 5% by mass in the dispersion, and the dispersion was stirred to prepare a mica dispersion.

Then the resin solution and the mica dispersion were mixed. To the resultant liquid, 3.10 part by mass of ethyleneoxide-modified surfactant (methanol solution) and 0.45 part by mass of sodium hydroxide were added and mixed. Thereby, a coating liquid for undercoat layer was prepared at 6.87% by mass of solid content.

The resultant coating liquid for undercoat layer was kept at the temperature of 40° C., then the coating liquid was applied on the front surface of the polyethylene resin layer of support A by means of an oblique-line gravure roller with 100 mesh and was dried, to form an undercoat layer on support A. The coated amount of the coating liquid for undercoat layer was 12.5 g/m² as prior to drying.

<Preparation of Coating Solution A for Recording Layer>

Preparation of Electron-Donating-Dye Precursor Capsule Liquid

As the electron-donating-dye precursor, 3.0 parts of crystal violet lactone was dissolved in 20 parts of ethyl acetate. 20 parts of alkyl naphthalene, which is a high boiling solvent, was added, and the resultant mixture was heated and mixed uniformly. As the capsule wall agent, 20 parts of a xylene diisocyanate/trimethylol propane addition product was added to this solution, and the resultant mixture was stirred uniformly. Separately, 54 parts of a 6% by mass aqueous solution of gelatin was provided, the previous electron-donating-dye precursor solution was added thereto, and the mixture was emulsified and dispersed by a homogenizer. 68 parts of water was added to the obtained emulsion liquid, and the mixture was made uniform. Thereafter, while stirring was carried out, the temperature was raised to 50° C., and an encapsulating reaction was allowed for 3 hours, such that the capsule liquid of the electron-donating-dye precursor was obtained. The average particle diameter of the capsules was 1.6 μm.

Preparation of Electron-Accepting Compound Dispersed Liquid

As the electron-accepting compound, 30 parts of bisphenol A was added to 150 parts of a 4% by mass aqueous solution of gelatin, and the resultant mixture was dispersed for 24 hours by a ball mill so as to prepare the dispersed liquid of electron-accepting compound. The average particle diameter of the electron-accepting compound in the dispersed liquid was 1.2 μm.

The capsule liquid of the electron-donating-dye precursor and the dispersed liquid of the electron-accepting compound were mixed together such that the ratio of the electron-donating-dye precursor/electron-accepting compound was ½, and the intended coating liquid A was prepared.

Preparation of Diazonium Salt Compound Capsule Liquid b

As the diazonium salt compound, 2.0 parts of 4-(N-2-(2,4-di-tert-amylphenoxy)butyryl)piperazinobenzenediazoniumhexafluorophosphate was dissolved in 20 parts of ethyl acetate. 20 parts of alkyl naphthalene, which is a high boiling point solvent, was added thereto, and the resultant mixture was heated and mixed uniformly. As the capsule wall agent, 15 parts of a xylylene diisocyanate/trimethylol propane addition product was added to this solution, and the resultant mixture was stirred uniformly. Separately, 54 parts of 6% by mass aqueous solution of gelatin was provided, and was added to the diazonium salt compound solution, and the mixture was emulsified and dispersed by a homogenizer. 68 parts of water was added to the obtained emulsion liquid, and the mixture was made uniform. Thereafter, while stirring was carried out, the temperature was raised to 40° C., an encapsulating reaction was carried out for 3 hours, and a diazonium salt compound capsule liquid b was obtained. The average particle diameter of the capsules was 1.1 μm.

Preparation of Coupler Emulsion Liquid b

As the coupler, 2 parts of 1-(2′-octylphenyl)-3-methyl-5-pyrazolone, 2 parts of 1,2,3-triphenylguanidine, 2 parts of 1,1-(p-hydroxyphenyl)-2-ethylhexane, 4 parts of 4,4′-(p-phenylenediisopropylidine)diphenol, 4 parts of 2-ethylhexyl-4-hydroxybenzoate, 0.3 parts of tricresylphosphate, 0.1 parts of diethyl maleate, and 1 part of 70% calcium dodecylbenzenesulfonate methanol solution were dissolved in 10 parts ethyl acetate. 80 parts of an 8% gelatin aqueous solution were added to this solution, and the mixture was emulsified for 10 minutes in a homogenizer. Thereafter, the ethyl acetate was removed to obtain coupler emulsion liquid b.

The above diazonium salt compound capsule liquid b and coupler emulsion liquid b were mixed together such that the diazonium salt compound/coupler ratio was ⅔, and the intended coating solution B was prepared.

<Preparation of Coating Solution C for Recording Layer>

Preparation of Diazonium Salt Compound Capsule Liquid c

As the diazonium salt compound, 3.0 parts of 2,5-dibutoxy-4-tolylthiobenzenediazoniumhexafluorophosphate was dissolved in 20 parts of ethyl acetate. 20 parts of alkyl naphthalene, which is a high boiling point solvent, was added thereto, and the resultant mixture was heated and mixed uniformly. As the capsule wall agent, 15 parts of a xylylene diisocyanate/trimethylol propane addition product was added to this solution, and the resultant mixture was stirred uniformly. Separately, 54 parts of a 6% aqueous solution of gelatin was provided, and was added to the diazonium salt compound solution, and the mixture was emulsified and dispersed by a homogenizer. 68 parts water was added to the obtained emulsion liquid, and the mixture was made uniform. Thereafter, while stirring was carried out, the temperature was raised to 40° C., an encapsulating reaction was carried out for 3 hours, and a diazonium salt compound capsule liquid c was obtained. The average particle diameter of the capsules was 1.0 μm.

Preparation of Coupler Emulsion Liquid c

As the coupler, 2 parts of 2-chloro-5-(3-(2,4-di-tert-pentyl)phenoxypropylamino)acetoacetoani lide, 2 parts of 1,2,3-triphenylguanidine, 2 parts of 1,1-(p-hydroxyphenyl)-2-ethylhexane, 4 parts of 4,4′-(p-phenylenediisopropylidene)diphenol, 4 parts of 2-ethylhexyl-4-hydroxybenzoate, 0.3 parts of tricresylphosphate, 0.1 parts of diethyl maleate, and 1 part of a 70% calcium dodecylbenzenesulfonate methanol solution were dissolved in 10 parts ethyl acetate. 80 parts of an 8% gelatin aqueous solution were added to this solution, and the mixture was emulsified for 10 minutes in a homogenizer. Thereafter, the ethyl acetate was removed to obtain coupler emulsion liquid c.

The above diazonium salt compound capsule liquid c and coupler emulsion liquid c were mixed together such that the diazonium salt compound/coupler ratio was ⅘, and the intended coating solution C was prepared.

<Preparation of Coating Solution for Light Transmittance Adjusting Layer>

Preparation of UV Absorbent Precursor Capsule Liquid

As a UV absorbent precursor, 10 parts of [2-aryl-6-(2H-benzotriazole-2-yl)-4-t-octylphenyl]benzenesulfonate, 3 parts of 2,5-di-t-octyl-hydroquinone, 2 parts of tricresylphosphate, and 4 parts of .alpha.-methyl styrene dimer were dissolved in 30 parts of ethyl acetate. As a capsule wall agent, 20 parts of a xylylene diisocyanate/trimethylol propane addition product was added to this solution, and the resultant solution was stirred uniformly such that a UV absorbent precursor solution was obtained. Separately, 200 parts of an 8% itaconic acid denatured polyvinyl alcohol aqueous solution was readied, and the above UV absorbent precursor solution was added thereto. The resultant mixture was emulsified and dispersed in a homogenizer. 120 parts of water was added to the obtained emulsion, and the solution was made uniform. Thereafter, while stirring was carried out, the temperature was raised to 40° C., and an encapsulating reaction was carried out for 3 hours so as to obtain a UV absorbent precursor encapsulating microcapsule liquid. The average particle diameter of the microcapsules was 0.3 μm.

10 parts of a 2% by mass aqueous solution of sodium [4-nonylphenoxytrioxyethylene]butyl sulfonate was added to 100 parts of the above UV absorbent precursor encapsulating microcapsule liquid, and a coating solution for the light transmittance adjusting layer was obtained.

<Preparation of Coating Solution for Intermediate Layer>

2 parts of 2% by mass solution of sodium (4-nonylphenoxytrioxyethylene)butyl sulfonate was added to 100 parts of a 10% by mass gelatin aqueous solution, so as to prepare a coating solution for intermediate layer.

<Preparation of Coating Solution for Protective Layer>

2.0 parts of a 20.5% by mass zinc stearate dispersion liquid (HYDRINE F115, manufactured by Chukyo Yushi KK) were added to 61 parts of a 5.0% by mass ethylene denatured polyvinyl alcohol aqueous solution. Further, 8.4 parts of a 2% by mass aqueous solution of sodium (4-nonylphenoxytrioxyethylene)butyl sulfonate, 8.0 parts of a fluorine based mold releasing agent (ME-313, manufactured by Daikin KK), and 0.5 parts of wheat flour starch were added thereto, and the mixture was stirred uniformly to prepare liquid A.

Separately, 12.5 parts of 20% by mass aqueous solution of KAOGROS (manufactured by Shiraishi Kogyo KK), 1.25 parts of 10% by mass aqueous solution of polyvinyl alcohol (PVA105, manufactured by Kuraray Co., Ltd.), and 0.39 parts of 2% by mass aqueous solution of sodium dodecylsulfonate were mixed together, and dispersed in a dynomill so as to prepare liquid B. 4.4 parts of liquid B were added to 80 parts liquid A, to prepare the coating solution for a protective layer.

<Formation of Recording Layer>

On the undercoat layer formed on support A, thermosensitive-recording layer A, the intermediate layer, thermosensitive-recording layer B, the intermediate layer, thermosensitive-recording layer C, the light transmittance adjusting layer, and the protective layer were continuously coated at a coating speed of 60 m/min, in that order such that seven layers were formed simultaneously. The structure was dried under conditions of 30° C. and 30% RH, and of 40° C. and 30% RH, so as to prepare the color thermosensitive-recording material according to the present invention. The coated amounts of solids of the respective layers were 6.0 g/m² for the recording layer A, 3.0 g/m² for the intermediate layer, 6.0 g/m² for the recording layer B, 3.0 g/m² for the intermediate layer, 5.0 g/m² for the thermosensitive-recording layer C, 3.0 g/m² for the transmittance adjusting layer, and 1.5 g/m² for the protective layer. As the result, a color thermosensitive-recording material was prepared.

<Image Recording>

Using the resultant color thermosensitive-recording material, an alternative pattern of black (concentration gradation: 0) and white (concentration gradation: 255) with 1 mm of line width was printed by means of a commercial printer (FUJIX NC-660A, by Fuji Photo Film Co., Ltd.).

<Smoothening Treatment>

Then the thermosensitive-recording materials after image recording were subjected to smoothening treatment by means of the belt-type smoothening device (endless press) as shown in FIG. 3. In the smoothening treatment, heating temperature was 80° C., the conveying velocity of the thermosensitive-recording material was 1.0 mm/sec, and the temperature at separating was 80° C. or less.

Specifically, in the belt-type smoothing device (endless press) shown in FIG. 3, processing section 1 is equipped with belt 2, heating roller 3, pressure roller 4, tension rollers 5, cleaning roller 6, cooling device 7, and conveying rollers 8.

Heating roller 3 and a pair of the tension rollers 5 are arranged inside the belt 2. Belt 2 is rotatably spanned among heating roller 3 and tension rollers 5 arranged distant from the heating roller 3. Pressure roller 4 is arranged in contact with belt 2 and faces heating roller 3. A portion between pressure roller 4 and belt 2 is pressurized by pressure roller 4 and heating roller 3 to thereby form a nip portion. Cooling device 7 is arranged inside the belt 2 between heating roller 3 and one of tension rollers 5. Heating roller 3 is disposed upstream in a rotating direction of belt 2, and one of the tension rollers 5 is disposed downstream thereof. The two conveying rollers 8 are arranged so as to face the cooling device 7 with the interposition of belt 2. The distance between the two conveying rollers 8 is nearly equal to the distance between the nip and one of the conveying rollers 8 and the distance between the tension roller 5 and the other conveying roller 8. Cleaning roller 6 is arranged so as to face heating roller 3 with the interposition of the belt 2 in an opposite side to the pressure roller 4. The portion between cleaning roller 6 and belt 2 is pressurized by cleaning roller and heating roller 3. Heating roller 3, pressure roller 4, tension rollers 5, cleaning roller 6, and conveying rollers 8 synchronously rotate to thereby allow the belt 2 to revolve.

The thermosensitive-recording material 10 is smoothened by way of the flow as shown in FIG. 3.

In processing portion 1, the surface roughness of belt 2 was 0.8 μm as arithmetic mean roughness (Ra). The pressure between the rollers was 5 kgf/cm² as nip pressure.

The belt of the belt-type smoothening device was prepared as follows:

On a polyimide base layer as base material for belt, silicone rubber primer DY39-115 (by Dow Corning Toray Silicone Co., Ltd.) was applied; and after being allowed with air-drying for 30 minutes, an application solution prepared from 100 parts by mass of DY-35-796AB, which is a silicone rubber precursor, and 30 parts by mass of n-hexane was applied by immersion to form a coating; then a primary vulcanization was conducted at 120° C. for 10 minutes, thereby a silicone rubber layer of 40 μm thick was formed.

On the silicone rubber layer, a coating liquid prepared from 100 parts by mass of SIFEL 610 (precursor of fluorocarbon siloxane rubber, by Shin-Etsu Chemical Co., Ltd.) and 20 parts by mass of fluorine solvent (a mixture solvent of m-xylenehexafluoride, perfluoroalkane, and perfluoro-2-butyltetrahydrofuran) was applied by immersion to form a coating. Then, a primary vulcanization was conducted at 120° C. for 10 minutes, and a secondary vulcanization was conducted at 180° C. for 4 hours, thereby a belt was formed with fluorocarbon siloxane rubber layer having a thickness of 20 μm.

(Evaluation)

Relief Height (Smoothness)

The height difference derived from the gradation difference of the surface of the thermosensitive-recording material, which was printed the alternative pattern of black (concentration gradation: 0) and white (concentration gradation: 255) with 1 mm of line width, was determined as to the relief height by means of Surfcom E-ST-S52B (by Tokyo Seimitsu Co., Ltd.). The results were summarized in Table 1.

By the way, the relief height is required to be 4.0 μm or less from the viewpoint of high quality image.

Evaluation of Glossiness

The glossiness was determined at the black area of the surface of the thermosensitive-recording material, which was printed the alternative pattern of black (concentration gradation: 0) and white (concentration gradation: 255) with 1 mm of line width, in the condition that the incident angle and the reflection angle are 60° respectively. The results were summarized in Table 1.

By the way, the glossiness is required to be 90% or more from the viewpoint of high quality image.

Evaluation of Blistering

The thermosensitive-recording material after image recording was cut, and the cut surfaces of the thermosensitive-recording layer and undercoat layer were evaluated visually with respect to the occurrence of blistering.

The results of the evaluation were indicated as follows, and shown in Table 1.

A—No Blistering

B—Slight Occurrence of Blistering

C—Significant Occurrence of Blistering

### EXAMPLES 2 TO 5

The thermosensitive-recording materials of Examples 2 to 5 were prepared, according to the same manner as Example 1, except that the heating temperature and the conveying velocity were changed to those of Table 1.

The relief height, glossiness, and blistering occurrence were evaluated as to the resulting materials in the same manner as Example 1. The results are summarized in Table 1.

### COMPARATIVE EXAMPLE 1

The thermosensitive-recording material of Comparative Example 1 was prepared, in the same manner with Example 1, except that the smoothening treatment was not carried out.

The relief height, glossiness, and blistering occurrence were evaluated as to the resulting material in the same manner as Example 1. The results are summarized in Table 1.

### COMPARATIVE EXAMPLE 2

The thermosensitive-recording material of Comparative Example 2 was prepared, in the same manner as Example 1, except that the heating temperature in the smoothening treatment was changed to 70° C. and the conveying velocity was changed to 1.0 mm/sec.

The relief height, glossiness, and blistering occurrence were evaluated as to the resulting material in the same manner as Example 1. The results are summarized in Table 1.

### COMPARATIVE EXAMPLE 3

The thermosensitive-recording material of Comparative Example 3 was prepared, in the same manner as Example 1, except that the heating temperature in the smoothening treatment was changed to 170° C. and the conveying velocity was changed to 55.0 mm/sec.

The relief height, glossiness, and blistering occurrence were evaluated as to the resulting material in the same manner as Example 1. The results are summarized in Table 1.

TABLE 1

| | HeatingTemp. | Conveying Velocity | Relief Height | | |
|---|---|---|---|---|---|
| | ° C. | mm/sec | μm | Glossiness % | Blistering |
| Ex. 1 | 80 | 1.0 | 2.0 | 90.5 | A |
| Ex. 2 | 100 | 10 | 1.5 | 91.1 | A |
| Ex. 3 | 120 | 5.0 | 1.3 | 91.2 | A |
| Ex. 4 | 120 | 25 | 0.9 | 93.0 | A |
| Ex. 5 | 150 | 50 | 1.2 | 92.8 | A |
| Com. Ex. 1 | No Heating | No Conveying | 7.0 | 87.6 | A |
| Com. Ex. 2 | 70 | 1.0 | 5.6 | 88.0 | A |
| Com. Ex. 3 | 170 | 55.0 | 12.8 | 85.7 | B |

From the results of Examples 1 to 5 and Comparative Examples 1 to 3 shown in Table 1, it is demonstrated that the smoothening treatment after recording an image on the thermosensitive-recording material provides an image with better flatness and higher gloss.

### EXAMPLE 6

A color thermosensitive-recording material was prepared in the same manner as Example 1.

The resulting color thermosensitive-recording material was subjected to image forming of 60% cyan concentration (cyan concentration gradation: 102) by means of a commercial printer (FUJIX NC-660A, by Fuji Photo Film Co., Ltd.) modified as explained following, then it was subjected to a smoothening treatment.

The printer was modified such that the belt-type smoothening device is equipped as shown in FIG. 3. The belt-type smoothing device 1 shown in FIG. 3 is equipped with belt 2, heating roller 3, pressure roller 4, tension rollers 5, cleaning roller 6, cooling device 7, and conveying rollers 8. Heating roller 3 and a pair of the tension rollers 5 are arranged inside the belt 2. Belt 2 is rotatably spanned among heating roller 3 and tension rollers 5 arranged distant from the heating roller 3. Pressure roller 4 is arranged in contact with belt 2 and faces heating roller 3. A portion between pressure roller 4 and belt 2 is pressurized by pressure roller 4 and heating roller 3 to thereby form a nip portion.

The determined temperature of roll and conveying velocity are shown in Table 2. The pressure between heating roller 3 and pressure roller 4 was 5 kgf/cm² as nip pressure.

The belt of the belt-type smoothening device was prepared as follows:

On a polyimide base layer as base material for belt, silicone rubber primer DY39-115 (by Dow Corning Toray Silicone Co., Ltd.) was applied; and after being allowed with air-drying for 30 minutes, an application solution prepared from 100 parts by mass of DY-35-796AB, which is a silicone rubber precursor, and 30 parts by mass of n-hexane was applied by immersion to form a coating; then a primary vulcanization was conducted at 120° C. for 10 minutes, thereby a silicone rubber layer of 40 μm thick was formed.

On the silicone rubber layer, a coating liquid prepared from 100 parts by mass of SIFEL 610 (precursor of fluorocarbon siloxane rubber, by Shin-Etsu Chemical Co., Ltd.) and 20 parts by mass of fluorine solvent (a mixture solvent of m-xylenehexafluoride, perfluoroalkane, and perfluoro-2-butyltetrahydrofuran) was applied by immersion to form a coating. Then, a primary vulcanization was conducted at 120° C. for 10 minutes, and a secondary vulcanization was conducted at 180° C. for 4 hours, thereby a belt was formed with fluorocarbon siloxane rubber layer having a thickness of 20 μm.

Evaluation of Concentration Nonuniformity

The image recorded surface recorded at 60% cyan concentration was visually evaluated in accordance with the following standard.

[Evaluation Standard]

A—No detectable concentration nonuniformity

B—Almost no detectable concentration nonuniformity Somewhat detectable by sever observation

C—Somewhat detectable but not noticeable

D—Remarkably noticeable concentration nonuniformity

Evaluation of Glossiness

The image surface recorded at 60% cyan concentration was evaluated in the condition of incident angle and reflection angle being 60° respectively.

### EXAMPLES 7 TO 8

The thermosensitive-recording materials of Examples 7 and 8 were prepared in the same manner as Example 6, except that the heating temperature and the conveying velocity were changed to those of Table 2.

The concentration nonuniformity and glossiness were evaluated as to the resulting materials in the same manner as Example 6. The results are summarized in Table 2.

### EXAMPLE 9

The thermosensitive-recording material of Example 9 was prepared, according to the same manner as Example 6, except that support A was changed to support B.

The concentration nonuniformity and glossiness were evaluated as to the resulting material in the same manner as Example 6. The results are summarized in Table 2.

### COMPARATIVE EXAMPLE 4

The thermosensitive-recording material of Comparative Example 4 was prepared, according to the same manner as Example 6, except that support A was changed to support B and the smoothening treatment was not carried out.

The concentration nonuniformity and glossiness were evaluated as to the resulting material in the same manner as Example 6. The results are summarized in Table 2.

### COMPARATIVE EXAMPLE 5

The thermosensitive-recording material of Comparative Example 5 was prepared in the same manner as Example 6, except that the smoothening treatment was not carried out.

The concentration nonuniformity and glossiness were evaluated as to the resulting material in the same manner as Example 6. The results are summarized in Table 2.

TABLE 2

| | | Roll Temp. | Conveying Velocity | Nonuniform | Glossiness |
|---|---|---|---|---|---|
| | Support | ° C. | m/sec | Concentration | % |
| Ex. 6 | A | 50 | 1.0 | A | 88.7 |
| Ex. 7 | A | 100 | 10 | A | 89.5 |
| Ex. 8 | A | 140 | 50 | A | 91.2 |
| Ex. 9 | B | 100 | 10 | A | 91.6 |
| Com. Ex. 4 | B | No | No | B | 84.8 |
| Com. Ex. 5 | A | No | No | D | 81.3 |

From the results of Table 2, it is demonstrated that the materials of Comparative Examples 4 to 5 without the smoothening treatment exhibit evidently inferior nonuniform concentration and glossiness compared to those of Examples. Further, Examples 6 to 9 demonstrates that high quality image recording with high glossiness may be achieved owing to controlling nonuniform concentration, in spite of the coated amount of polyethylene resin being relatively low in the support.

### EXAMPLE 10

A color thermosensitive-recording material was prepared in the same manner as Example 1.

The resulting thermosensitive-recording material was subjected to smoothening treatment by means of belt-type smoothening device 1 as shown in FIG. 3, prior to subjecting to image recording. The belt-type smoothing device 1 as shown in FIG. 3 is equipped with belt 2, heating roller 3, pressure roller 4, tension rollers 5, cleaning roller 6, cooling device 7, and conveying rollers 8. Heating roller 3 and a pair of the tension rollers 5 are arranged inside the belt 2. Belt 2 is rotatably spanned among heating roller 3 and tension rollers 5 arranged distant from the heating roller 3. Pressure roller 4 is arranged in contact with belt 2 and faces heating roller 3. A portion between pressure roller 4 and belt 2 is pressurized by pressure roller 4 and heating roller 3 to thereby form a nip portion.

The set roll temperature and conveying velocity are shown in Table 3. The pressure between heating roller 3 and pressure roller 4 was 5 kgf/cm² as the nip pressure.

The belt of the belt-type smoothening device was prepared as follows:

On a polyimide base layer as base material for belt, silicone rubber primer DY39-115 (by Dow Corning Toray Silicone Co., Ltd.) was applied; and after being allowed with air-drying for 30 minutes, an application solution prepared from 100 parts by mass of DY-35-796AB, which is a silicone rubber precursor, and 30 parts by mass of n-hexane was applied by immersion to form a coating; then a primary vulcanization was conducted at 120° C. for 10 minutes, thereby a silicone rubber layer of 40 μm thick was formed.

On the silicone rubber layer, a coating liquid prepared from 100 parts by mass of SIFEL 610 (precursor of fluorocarbon siloxane rubber, by Shin-Etsu Chemical Co., Ltd.) and 20 parts by mass of fluorine solvent (a mixture solvent of m-xylenehexafluoride, perfluoroalkane, and perfluoro-2-butyltetrahydrofuran) was applied by immersion to form a coating. Then, a primary vulcanization was conducted at 120° C. for 10 minutes, and a secondary vulcanization was conducted at 180° C. for 4 hours, thereby a belt was formed with fluorocarbon siloxane rubber layer having a thickness of 20 μm.

<Image Recording>

The thermosensitive-recording material subjected to image recording was printed an image of 60% cyan concentration (cyan concentration gradation: 102) and an image of 100% black concentration by means of a commercial printer (FUTIX NC-660A, by Fuji Photo Film Co., Ltd.), then concentration nonuniformity and glossiness were evaluated as follows. The results are summarized in Table 3.

Evaluation of Concentration Nonuniformity

The image recorded surface recorded at 60% cyan concentration was visually evaluated in accordance with the following standard.

[Evaluation Standard]

A—No detectable concentration nonuniformity

B—Almost no detectable concentration nonuniformity Somewhat detectable by sever observation

C—Somewhat detectable but not noticeable

D—Remarkably noticeable concentration nonuniformity

Evaluation of Glossiness

The image recorded surface recorded at 60% cyan concentration was evaluated in the condition of incident angle and reflection angle being 60° respectively.

### EXAMPLES 11 TO 13

The thermosensitive-recording materials of Examples 11 to 13 were prepared in the same manner as Example 10, except that the heating temperature and the conveying velocity were changed to those of Table 3.

The concentration nonuniformity and glossiness were evaluated as to the resulting materials in the same manner as Example 10. The results are summarized in Table 3.

### EAMPLE 14

The thermosensitive-recording material of Example 14 was prepared, according to the same manner as Example 10, except that support A was changed to support B and the heating temperature and the conveying velocity in the smoothening treatment were changed to those of Table 3.

The concentration nonuniformity and glossiness were evaluated as to the resulting material in the same manner as Example 10. The results are summarized in Table 3.

### COMPARATIVE EXAMPLE 6

The thermosensitive-recording material of Comparative Example 6 was prepared in the same manner as Example 10, except that support A was changed to support B and the smoothening treatment was not carried out.

The concentration nonuniformity and glossiness were lo evaluated as to the resulting material in the same manner as Example 10. The results are summarized in Table 3.

### COMPARATIVE EXAMPLE 7

The thermosensitive-recording material of Comparative Example 7 was prepared in the same manner as Example 10, except that the smoothening treatment was not carried out.

The concentration nonuniformity and glossiness were evaluated as to the resulting material in the same manner as Example 10. The results are summarized in Table 3.

TABLE 3

| | | Roll Temp. | Conveying Velocity | Nonuniform | Glossiness |
|---|---|---|---|---|---|
| | Support | ° C. | m/sec | Concentration | % |
| Ex. 10 | A | 50 | 1.0 | B | 90.2 |
| Ex. 11 | A | 100 | 15 | A | 90.6 |
| Ex. 12 | A | 150 | 100 | A | 90.4 |
| Ex. 13 | A | 200 | 200 | A | 90.8 |
| Ex. 14 | B | 100 | 200 | A | 90.7 |
| Com. Ex. 6 | B | No | No | B | 87.5 |
| Com. Ex. 7 | A | No | No | D | 85.3 |

From the results of Table 3, it is demonstrated that the materials of Comparative Examples 6 and 7 without the smoothening treatment exhibit evidently inferior nonuniform concentration and glossiness compared to those of Examples. Further, Examples 10 to 14 demonstrates that high quality image recording with high glossiness may be achieved owing to controlling nonuniform concentration, in spite of the coated amount of polyethylene resin being relatively low in the support.

In accordance with the present invention, specific problems in the prior art may be resolved, and a thermosensitive-recording process may be provided that forms recorded images with high quality such as gloss, through controlling the blistering occurrence and enhancing the flatness.

Further, in accordance with the present invention, a thermosensitive-recording process and a thermosensitive-recording apparatus adapted to the process may be provided in which full-color images with high quality and high gloss are printable along with controlling the concentration nonuniformity of the recorded image surface in the recorded thermosensitive-recording material.

1. A thermosensitive-recording process comprising:
recording an image on a thermosensitive-recording material through heating the thermosensitive-recording material which comprises a thermosensitive-recording layer on a support, and smoothening the thermosensitive-recording material,
wherein said smoothening the thermosensitive-recording material is carried out during at least a period selected from (i) before recording the image, (ii) while recording the image, and (iii) after recording the image, and the heating temperature at smoothening the thermosensitive-recording material is above 70° C. and below 170° C.

2. The thermosensitive-recording process according to claim 1, wherein said smoothening the thermosensitive-recording material is carried out during a period of while recording the image on the thermosensitive-recording material and before the thermosensitive-recording layer adjacent to the support is subjected to image recording.

3. The thermosensitive-recording process according to claim 2, wherein the thermosensitive-recording layer adjacent to the support is a cyan thermosensitive-recording layer.

4. The thermosensitive-recording process according to claim 1, wherein the thermosensitive-recording material comprises the support, the first thermosensitive-recording layer, the second thermosensitive-recording layer, and the third thermosensitive-recording material in order.

5. The thermosensitive-recording process according to claim 4, wherein said smoothening the thermosensitive-recording material is carried out while said recording the image on the thermosensitive-recording material,
wherein said recording the image on the thermosensitive-recording material is conducted by a primary image recording, in which at least one of the second thermosensitive-recording layer and the third thermosensitive-recording layer is subjected to image recording, and by a subsequent secondary image recording, in which the remaining un-coloring thermosensitive-recording layer is subjected to image recording, and
wherein said smoothening the thermosensitive-recording material is carried out during a period of after the primary image recording and before the secondary image recording.

6. The thermosensitive-recording process according to claim 1, wherein said smoothening the thermosensitive-recording material is carried out by means of a pair of rollers.

7. The thermosensitive-recording process according to claim 1, wherein said smoothening the thermosensitive-recording material is carried out by means of a belt-type smoothening device.

8. The thermosensitive-recording process according to claim 7, wherein the belt-type smoothening device comprises a belt member, a heating and pressing unit, and a cooling unit.

9. The thermosensitive-recording process according to claim 8, wherein the image recording surface of the thermosensitive-recording material is brought into contact with the surface of the belt member, the thermosensitive-recording material is subjected to smoothening by means of the heating and pressing unit, and the thermosensitive-recording material is cooled, then the thermosensitive-recording material is separated from the belt member.

10. The thermosensitive-recording process according to claim 1, wherein the conveying velocity of the thermosensitive-recording material at said smoothening the thermosensitive-recording material is 1 to 200 mm/sec.

11. The thermosensitive-recording process according to claim 1, wherein the support is selected from the group consisting of raw paper, synthetic paper, synthetic resin sheet, coated paper, and laminated paper.

12. The thermosensitive-recording process according to claim 11, wherein the laminate paper comprises a raw paper, and polyolefin resin layers coated on both sides of the raw paper.

13. The thermosensitive-recording process according to claim 1, wherein the thermosensitive-recording material comprises a protective layer as an outermost layer, the protective layer contains a polymer, the second-order transition temperature of the polymer is 60° C. or more, and the melting point of the polymer is 250° C. or less.

14. The thermosensitive-recording process according to claim 13, wherein the polymer is polyvinyl alcohol.

15. A thermosensitive-recording apparatus comprising:
an image recording unit, and
a smoothening unit,
wherein the image recording unit serves to record an image on a thermosensitive-recording material through heating the thermosensitive-recording material which comprises a lo thermosensitive-recording layer on a support, and the smoothening unit serves to smoothen the thermosensitive-recording material,
wherein the smoothening unit operates during at least a period selected from (i) before recording the image, (ii) while recording the image, and (iii) after recording the image, and the heating temperature at smoothening the thermosensitive-recording material is above 70° C. and below 170° C.

16. The thermosensitive-recording apparatus according to claim 15, the smoothening unit operates during a period of while recording the image on the thermosensitive-recording material and before the thermosensitive-recording layer adjacent to the support undergoes image recording.

17. The thermosensitive-recording apparatus according to claim 16, wherein the thermosensitive-recording layer adjacent to the support is a cyan thermosensitive-recording layer.

18. The thermosensitive-recording apparatus according to claim 15, wherein the thermosensitive-recording material comprises the support, the first thermosensitive-recording layer, the second thermosensitive-recording layer, and the third thermosensitive-recording material in order.

19. The thermosensitive-recording apparatus according to claim 18, wherein the smoothening unit operates while recording the image on the thermosensitive-recording material,
wherein said recording the image on the thermosensitive-recording material is conducted by a primary image recording, in which at least one of the second thermosensitive-recording layer and the third thermosensitive-recording layer is subjected to image recording, and by a subsequent secondary image recording, in which the remaining un-coloring thermosensitive-recording layer is subjected to image recording, and
wherein said smoothening the thermosensitive-recording material is carried out during a period of after the primary image recording and before the secondary image recording.

20. The thermosensitive-recording apparatus according to claim 15, wherein the conveying velocity of the thermosensitive-recording material at smoothening the thermosensitive-recording material is 1 to 200 mm/sec.

21. The thermosensitive-recording apparatus according to claim 15, wherein the smoothening unit is a pair of rollers.

22. The thermosensitive-recording apparatus according to claim 15, wherein the smoothening unit is a belt-type smoothening device.

23. The thermosensitive-recording apparatus according to claim 22, wherein the belt-type smoothening device comprises a belt member, a heating and pressing unit, and a cooling unit.

24. The thermosensitive-recording apparatus according to claim 23, wherein the belt member comprises a layer of fluorocarbon siloxane rubber on the belt member.

25. The thermosensitive-recording apparatus according to claim 24, wherein the fluorocarbon siloxane rubber comprises one of perfluoroalkylether group and perfluoroalkyl group as the backbone chain of the fluorocarbon siloxane.

26. The thermosensitive-recording apparatus according to claim 22, wherein a layer of silicone rubber exists on the belt member, and a layer of fluorocarbon siloxane rubber exists on the layer of silicone rubber.

27. The thermosensitive-recording apparatus according to claim 26, wherein the fluorocarbon siloxane rubber comprises one of perfluoroalkylether group and perfluoroalkyl group as the backbone chain of the fluorocarbon siloxane.
